(19) United States
(12) Patent Application Publication
(10) Pub. No.: US 2011/0119592 A1
(43) Pub. Date: May 19, 2011

(54) Network system and managing method

(75) Inventor: Seiji Tada, Osaka (JP)

(73) Assignee: Sharp Kabushiki Kaisha, Osaka (JP)

(21) Appl. No.: 12/927,477

(22) Filed: Nov. 16, 2010

(30) Foreign Application Priority Data
Nov. 16, 2009 (JP) JP2009-260794

(51) Int. Cl. G06F 3/01

(52) U.S. Cl. 715/736

(57) ABSTRACT

Each of a plurality of displays transmits an operation state of the display to a management device. The management device stores the operation states corresponding to the plurality of displays in a memory. Based on the operation states corresponding to the plurality of displays and stored in the memory, the management device transmits a command for causing the display to perform the same operation as the other displays. Each of the plurality of displays changes the operation state of the display based on the command provided from the management device.

This nonprovisional application is based on Japanese Patent Application No. 2009-260794 filed on Nov. 16, 2009 with the Japan Patent Office, the entire contents of which are hereby incorporated by reference.

### BACKGROUND OF THE INVENTION

1. Field of the Invention

The present invention relates to a network system including a plurality of displays for displaying pictures as well as a managing method, and particularly to a network system and a managing method for unifying or matching operation states of the plurality of displays with each other.

2. Description of the Background Art

A plurality of public displays display the same pictures according to the same timing in some cases. For example, a plurality of public displays arranged in a station display a service situation of trains from five o'clock in the morning to one o'clock in the midnight.

For management of these displays, a management server or a management PC (Personal Computer) obtains, over an LAN (Local Area Network) or an RS-232C (Recommended Standard 232C), information indicating that the display is normally operating or not. By using the management server or the management PC, a manager or administrator recognizes a failure that occurred in a certain display, and will restore it.

For example, Japanese Patent Laying-Open No. 10-021163 (Patent Document 1) has disclosed an image display control method. According to Japanese Patent Laying-Open No. 10-021163 (Patent Document 1), the image display control method includes an attitude code producing step of producing an attitude code that is a numeric code representing an attitude for displaying an original image, an attitude transmitting step of transmitting the attitude code to another terminal over a communications network, and an image display step of displaying an image subjected to image rotation and/or image inversion according to the attitude code. The attitude code transmitting step includes a transmission sub-step of transmitting the attitude code to the communications network, and a receiving sub-step of receiving the attitude code.

Japanese Patent Laying-Open No. 2000-029314 (Patent Document 2) has disclosed a multi-display system. According to Japanese Patent Laying-Open No. 2000-029314 (Patent Document 2), the multi-display system includes a host device providing a video signal, a plurality of display devices displaying an image based on the video signal, a display control device connected to each display device for controlling an image display state of each display device independently of the others based on the video signal, and an input device for entering information by a viewer of the display device according to the displayed image. This multi-media system produces time information relating to a time of display of the image by the display control device and a time of information entry by the input means.

In the conventional network system including the plurality of displays, the manager is required to check or determine the operation states of the plurality of displays, using the management server or the management PC. Thus, in the conventional network system, it is impossible to unify automatically the operations of the plurality of displays, and thus it is impossible to restore automatically an abnormal display to a proper state, which results in a disadvantage of increase of labor costs.

### SUMMARY OF THE INVENTION

The invention has been made for overcoming the above problems, and it is an object of the invention to provide a network system and a managing method that can unify operations of a plurality of display systems.

According to an aspect, the invention provides a network system including a plurality of displays and a managing device. Each of the plurality of displays includes a screen, a first interface for communicating with the managing device, and a first processor for transmitting an operation state of the display through the first interface to the managing device and controlling the display based on a command provided from the managing device. The managing device includes a second interface for communicating with the plurality of displays, a memory for storing the operation states corresponding to the plurality of displays, respectively, and a second processor for transmitting, through the second interface, to one of the displays the command for causing one of the displays to perform the same operation as the other displays, based on the operation states, stored in said memory, corresponding to the plurality of displays.

Preferably, the managing device is a display including a screen. The second processor operates to store the operation state of the managing device in the memory, and to cause the managing device to perform the same operation as the other displays based on the operation states corresponding to the managing device and the plurality of displays and stored in the memory.

Preferably, the second processor determines whether the operation states corresponding to the plurality of displays are the same operation state or not, with reference to the memory and, when a difference is present between the operation states, transmits the command to the display other than the displays corresponding to the largest value in number by making a comparison in number between the displays corresponding to the respective different operation states.

Preferably, the network system further includes a contents output device for providing contents. Each of the displays further includes a third interface for communicating with the contents output device. The first processor displays on the screen the contents received from the contents output device through the third interface.

Preferably, the third interface includes a plurality of input terminals. The operation state includes a state of selection of the input terminal receiving the contents being displayed on the screen.

Preferably, the operation state includes an attribute of an input signal of the contents being displayed on the screen.

Preferably, when an attribute of an input signal of the one of the displays is different from attributes of the input signals of the other displays, said first processor changes the input destination of said contents to another input destination, and then restores the input destination based on said command.

Preferably, the operation state includes an on/off state of a power.

Preferably, when the managing device is powered on, the second processor transmits the command to the display through the second interface based on the operation state corresponding to the plurality of displays.

Preferably, the network system further includes a management terminal for communicating with the managing device. The second processor receives the operation state from the plurality of displays after transmitting the command, determines whether the plurality of displays are in the same operation state or not, and, when the plurality of display devices are not in the same operation state, transmits an alarm to the management terminal through the first communication interface.

According to another aspect, the invention provides a network system including a plurality of displays. Each of the plurality of displays includes a screen, a first interface for communicating with the other displays, a first processor for transmitting an operation state of one of the displays to the other displays and receiving the operation states from the other displays through the first interface, and a memory for storing the operation states corresponding to the plurality of displays. The first processor causes the display to perform the same operation as the other displays based on the operation state corresponding to the plurality of displays.

According to still another aspect, the invention provides a managing method in a network system including a plurality of displays and a managing device. The managing method includes the steps of transmitting, by each of the plurality of displays, an operation state of the display to the managing device; storing, by the managing device, the operation states corresponding to the plurality of displays in a memory; transmitting, by the managing device, the command for causing the display to perform the same operation as the other displays based on the operation states corresponding to the plurality of displays; and changing, by each of the plurality of displays, the operation state of the display based on a command provided from the managing device.

According to further another aspect, the invention provides a managing method in a network system including a plurality of displays. The managing method includes the steps of transmitting, by each of the plurality of displays, an operation state of the display to the different display; storing, by each of the plurality of displays, the operation states corresponding the plurality of displays in the memory; and changing, by each of the plurality of displays, the operation state of the display to the same operation state as the other displays, based on the operation states corresponding to the plurality of displays.

As described above, the invention provides the network system and the managing method that can automatically unify the operations of the plurality of displays.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an image view showing a whole structure of a network system according to first and second embodiments.

FIG. 2 is a first image diagram showing an operation summary of the network system according to the embodiment.

FIG. 3 is a second image diagram showing an operation summary of the network system according to the embodiment.

FIG. 4 is a third image diagram showing an operation summary of the network system according to the embodiment.

FIG. 5 is a fourth image diagram showing an operation summary of the network system according to the embodiment.

FIG. 6 is a block diagram showing a structure of a display (management display) according to the first and second embodiment.

FIG. 7 is an image diagram showing restoring processing executed in signal state restoring processing.

FIG. 8 is an image diagram showing restoring processing executed in lamp state restoring processing.

FIG. 9 is a flowchart showing a processing procedure of determining processing in the display according to the first embodiment.

FIG. 10 is a flowchart showing processing procedure of power restoring processing in the display according to the first embodiment.

FIG. 11 is a flowchart showing processing procedure of input mode restoring processing in the display according to the first embodiment.

FIG. 12 is a first flowchart showing processing procedure of signal state restoring processing in the display according to the first embodiment.

FIG. 13 is a second flowchart showing the processing procedure of the signal state restoring processing in the display according to the first embodiment.

FIG. 14 is a flowchart showing the processing procedure of the lamp state restoring processing in the display according to the first embodiment.

FIG. 15 is a flowchart showing the processing procedure of the determining processing in the management display according to the second embodiment.

FIG. 16 is a flowchart showing the processing procedure of the power restoring processing in the management display (management sever) according to the second and third embodiments.

FIG. 17 is a flowchart showing the processing procedure of the input mode restoring processing in the management display (management sever) according to the second and third embodiments.

FIG. 18 is a first flowchart showing the processing procedure of the signal state restoring processing in the management display (management sever) according to the second and third embodiments.

FIG. 19 is a second flowchart showing the processing procedure of the signal state restoring processing in the management display (management sever) according to the second and third embodiments.

FIG. 20 is a flowchart showing the processing procedure of the lamp state restoring processing in the management display (management sever) according to the second and third embodiments.

FIG. 21 is an image diagram showing a whole structure of the network system according to the third embodiments.

FIG. 22 is a block diagram showing a structure of the management server according to the third embodiment.

FIG. 23 is a flowchart showing the processing procedure of the power restoring processing in the management server according to the third embodiment.

### DESCRIPTION OF THE PREFERRED EMBODIMENTS

Embodiments of the invention will now be described with reference to the drawings. In the following description, the same parts bear the same reference numbers and the same names, and achieve the same functions. Therefore, description thereof is not repeated.

### First Embodiment

### <Whole Structure of a Network System 1A>

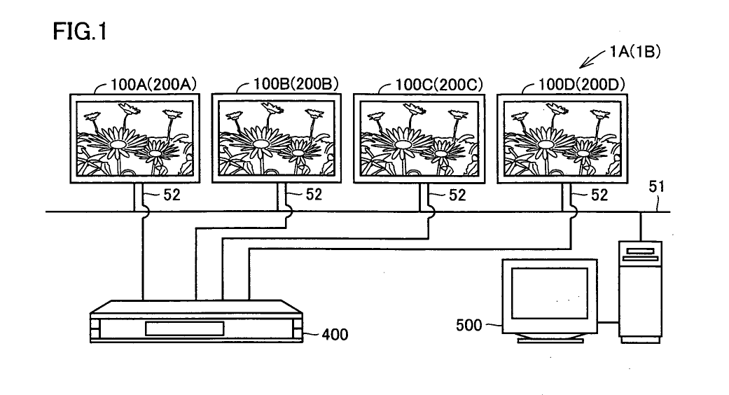

First, description will be given on a whole structure of a network system 1A according to an embodiment. FIG. 1 is an image diagram showing the whole structure of network system 1A according to the embodiment.

Referring to FIG. 1, network system 1A includes a plurality of displays 100A, 100B, 100C and 100D, a contents output device 400 and a management PC 500. Each of displays 100A, 100B, 100C and 100D performs mutual communications with management PC 500 over a first network 51. Each of displays 100A, 100B, 100C and 100D performs mutual communications with contents output device 400 over a second network 52.

LCD or plasma televisions or the like implement the plurality of displays 100A, 100B, 100C and 100D, respectively. For example, a wired or wireless LAN, RS-232C, HDMI-CEC (High Definition Multimedia Interface-Consumer Electrons Control) or the like implements each of first and second networks 51 and 52.

However, management PC 500 and contents output device 400 may be the same device. First and second networks 51 and 52 may be the same network. Network system 1A may include a plurality of contents output devices 400. In this case, the plurality of displays 100A, 100B, 100C and 100D receive different contents through a plurality of input terminals from the plurality of contents output devices 400, respectively.

Alternatively, contents output device 400 may output a plurality of contents through different output terminals, respectively. In this case, the plurality of displays 100A, 100B, 100C and 100D receive the different contents from the different output terminals of contents output device 400 through the plurality of input terminals, respectively.

The plurality of displays 100A, 100B, 100C and 100D display the contents received from contents output device 400 through second network 52. In this embodiment, the plurality of displays 100A, 100B, 100C and 100D receive the same contents from contents output device 400, and display the received same contents.

<Operation Summary 1 of Network System 1A>

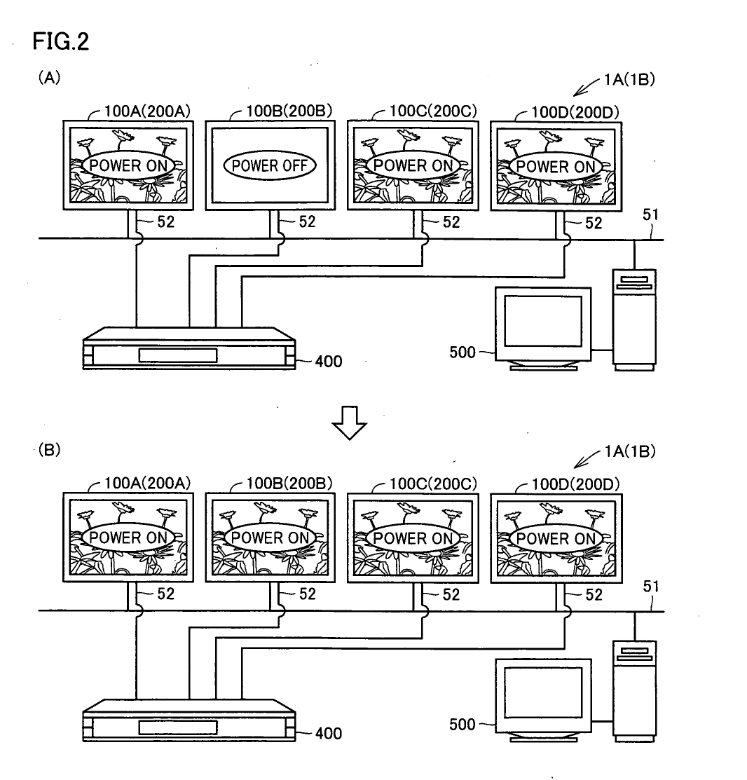

Description will now be given on an operation summary of network system 1A according to the embodiment. FIG. 2 is a first image diagram showing the operation summary of network system 1A according to the embodiment. More specifically, FIG. 2(A) shows a state in which display 100B is in an operation state different from those of other displays 100A, 100C and 100D. FIG. 2(B) shows a state in which display 100 is restored to the same operation state as other displays 100A, 100C and 100D.

The following description will be given on the case in which a soft-power of display 100B is off, and soft-powers of other displays 100A, 100C and 100D are on as shown in FIG. 2(A). The state in which the soft-power is off means a so-called standby state in which a main power is on and a sub-power is off. Although the following description will be given on the operation of display 100B, other displays 100A, 100C and 100D can execute substantially the same operation.

Periodically, or when the main power is turned on, display 100B obtains the operation state from each of other displays 100A, 100C and 100D. Based on the operation states of displays 100A, 100B, 100C and 100D, display 100B determines whether the operation state of display 100B is different from those of other displays 100A, 100C and 100D, or not. Thus, display 100B determines whether other displays 100A, 100C and 100D are in the soft-power off state or not.

When the operation state of display 100B is different from those of other displays 100A, 100C and 100D, i.e., when the soft-powers of other displays 100A, 100C and 100D are on, display 100B turns on the soft-power. Thus, as shown in FIG. 2(B), the soft powers of all displays 100A, 100B, 100C and 100D are turned on.

More specifically, display 100B changes to the operation state to which the most displays belong, based on the operation states of respective displays 100A, 100B, 100C and 100D.

As described above, all displays 100A, 100B, 100C and 100D in network system 1A according to the embodiment automatically attain the same operation state.

<Operation Summary 2 of Network System 1A>

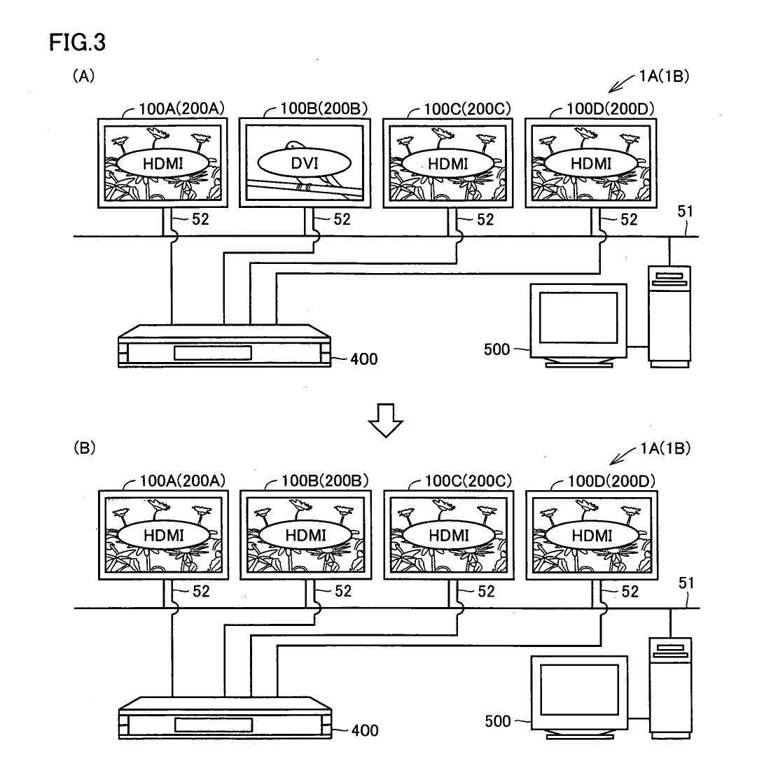

FIG. 3 is a second image diagram showing an operation summary of network system 1A according to the embodiment. More specifically, FIG. 3(A) shows a state in which display 100B is in an operation state different from those of other displays 100A, 100C and 100D. FIG. 3(B) shows a state in which display 100 is restored to the same operation state as other displays 100A, 100C and 100D.

Description will be given on the case where display 100B displays first contents received through a DVI (Digital Visual Interface) terminal, and other displays 100A, 100C and 100D display second contents received through the HDMI terminal, as shown in FIG. 3(A). Although the following description will be given on the operation of display 100B, other displays 100A, 100C and 100D can execute substantially the same operation.

Periodically, or when the main power is turned on, display 100B obtains the operation state from each of other displays 100A, 100C and 100D. Based on the operation states of displays 100A, 100B, 100C and 100D, display 100B determines whether the operation state of display 100B is different from those of other displays 100A, 100C and 100D or not. Thus, display 100B determines whether other displays 100A, 100C and 100D are displaying the contents received through the DVI terminals or not.

When the operation state of display 100B is different from those of other displays 100A, 100C and 100D, i.e., when other displays 100A, 100C and 100D are displaying the contents received through the HDMI terminals, display 100B changes the input terminal to the HDMI terminal. Thus, as shown in FIG. 3(B), all displays 100A, 100B, 100C and 100D display the contents received through the HDMI terminals.

More specifically, display 100B changes to the operation state to which the most displays belong, based on the operation states of respective displays 100A, 100B, 100C and 100D.

In network system 1A according to the embodiment, as described above, all displays 100A, 100B, 100C and 100D automatically attain the same operation state.

<Operation Summary 3 of Network System 1A>

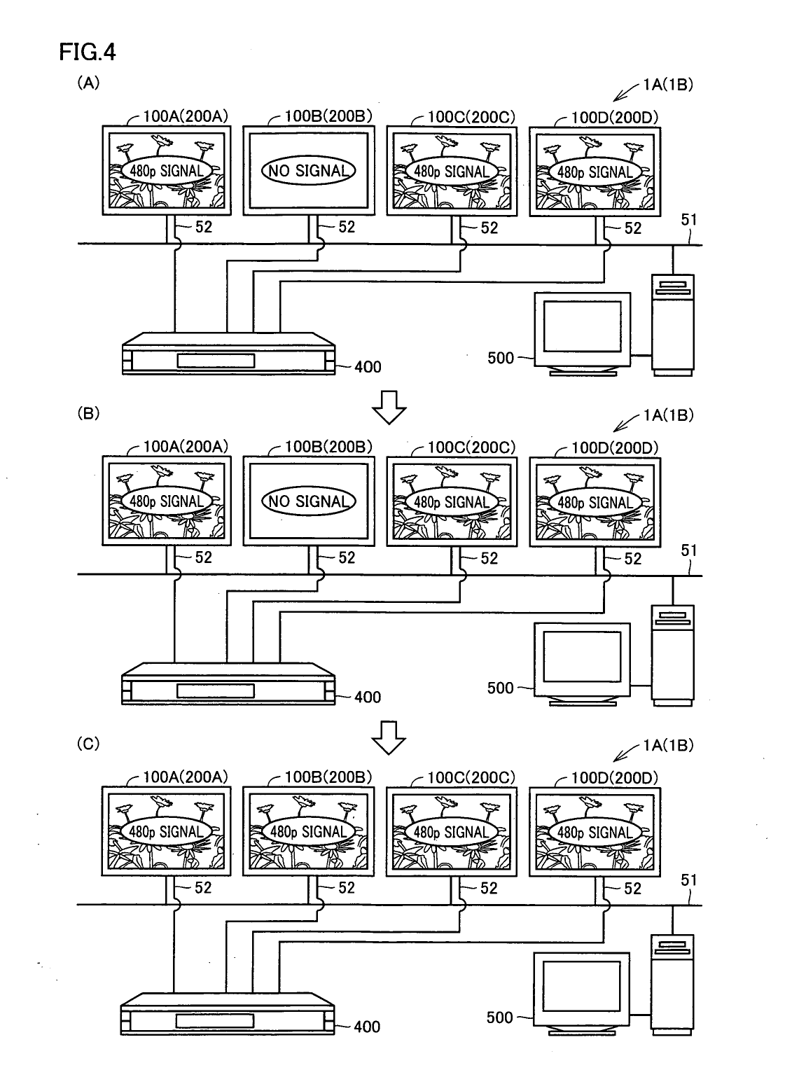

FIG. 4 is a third image diagram showing an operation summary of network system 1A according to the embodiment. More specifically, FIG. 4(A) shows a state in which display 100B is in an operation state different from those of other displays 100A, 100C and 100D. FIG. 4(B) shows a state in which display 100B is still in an operation state different from those of other displays 100A, 100C and 100D. FIG. 4(C) shows a state in which display 100 is restored to the same operation state as other displays 100A, 100C and 100D.

Description will now be given on the case where display 100B is not receiving the signal from contents output device 400, and other displays 100A, 100C and 100D are receiving the signals in the format of 480p, as shown in FIG. 4(A). Although the following description will be given on the operation of display 100B, other displays 100A, 100C and 100D can execute substantially the same operation.

Periodically, or when the main power is turned on, display 100B obtains the operation state from each of other displays 100A, 100C and 100D. Based on the operation states of displays 100A, 100B, 100C and 100D, display 100B determines whether the operation state of display 100B is different from those of other displays 100A, 100C and 100D or not. Thus, display 100B determines whether other displays 100A, 100C and 100D are not receiving the signal or not.

When the operation state of display 100B is different from those of other displays 100A, 100C and 100D, i.e., when other displays 100A, 100C and 100D are receiving the 480p signal, display 100B restarts. As shown in FIG. 4(B), however, display 100B does not receive the signal of the 480p format in some cases even after display 100B restarted.

In this case, display 100B restarts contents output device 400. Thereby, as shown in FIG. 4(C), all displays 100A, 100B, 100C and 100D enter the state of receiving the signals of the 480p format from contents output device 400.

More specifically, display 100B changes to the operation state to which the most displays belong, based on the operation states of respective displays 100A, 100B, 100C and 100D.

In network system 1A according to the embodiment, as described above, all displays 100A, 100B, 100C and 100D automatically attain the same operation state.

<Operation Summary 4 of Network System 1A>

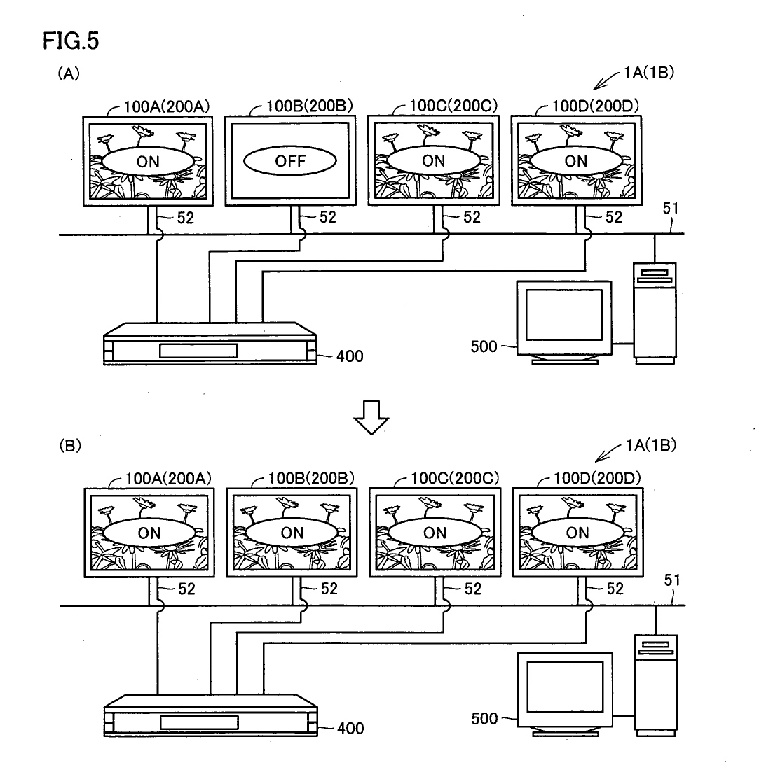

FIG. 5 is a fourth image diagram showing an operation summary of network system 1A according to the embodiment. More specifically, FIG. 5(A) shows a state in which display 100B is in an operation state different from those of other displays 100A, 100C and 100D. FIG. 5(B) shows a state in which display 100 is restored to the same operation state as other displays 100A, 100C and 100D.

Description will now be given on the case where a back light of display 100B is off, and back lights of other displays 100A, 100C and 100D are on, as shown in FIG. 5(A). Although the following description will be given on the operation of display 100B, other displays 100A, 100C and 100D can execute substantially the same operation.

Periodically, or when the main power is turned on, display 100B obtains the operation state from each of other displays 100A, 100C and 100D. Based on the operation states of displays 100A, 100B, 100C and 100D, display 100B determines whether the operation state of display 100B is different from those of other displays 100A, 100C and 100D or not. Thus, display 100B determines whether the back lights of other displays 100A, 100C and 100D are off or not.

When the operation state of display 100B is different from those of other displays 100A, 100C and 100D, i.e., when the back light of other displays 100A, 100C and 100D are on, display 100B turns on the back light. Thus, as shown in FIG. 5(B), all displays 100A, 100B, 100C and 100D turn on the back lights.

More specifically, display 100B changes to the operation state to which the most displays belong, based on the operation states of respective displays 100A, 100B, 100C and 100D.

In network system 1A according to the embodiment, as described above, all displays 100A, 100B, 100C and 100D automatically attain the same operation state.

Description will now be given on the structure of network system 1A for implementing the above functions. In the following description, displays 100A, 100B, 100C and 100D may be generally referred to as displays 100.

<Structure of Display 100>

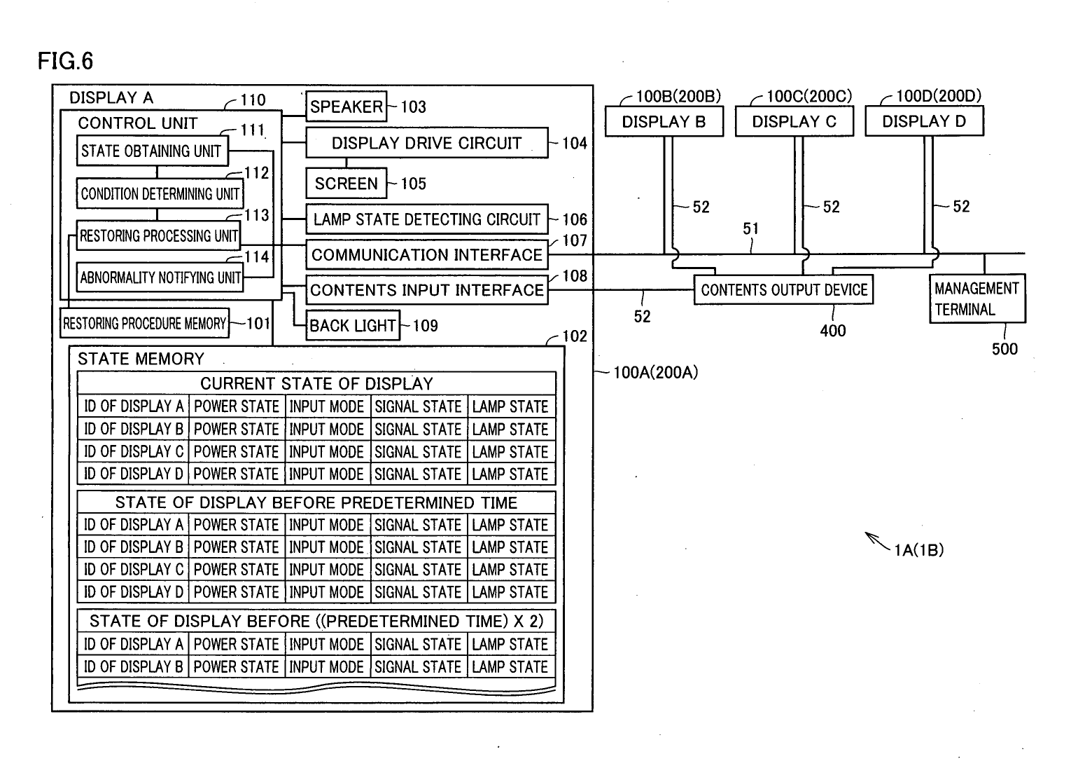

A form of a specific structure of display 100 according to the embodiment will be described below. FIG. 6 is a block diagram showing a structure of display 100 according to the embodiment. Referring to FIG. 6, display 100 includes, as major components, a control unit 110, a restoring procedure memory 101, a state memory 102, a speaker 103, a display drive circuit 104, a screen 105, a lamp state detecting circuit 106, a communication interface 107, a contents input interface 108 and a back light 109.

Each of restoring procedure memory 101 and state memory 102 is implemented, e.g., by an SRAM (Static Random Access Memory), NV-RAM, hard disk, ROM (Read-Only Memory), mask ROM, EPROM (Erasable Programmable Read-Only Memory), EEPROM (Electrically Erasable Programmable Read-Only Memory), flash memory or the like. Restoring procedure memory 101 and state memory 102 may be implemented by the same recording medium, and may also be implemented by different recording mediums, respectively.

Restoring procedure memory 101 contains a program for changing the operation state, i.e., for restoring display 100.

State memory 102 stores the operation state of each of displays 100 included in network system 1A. In a time series, i.e., according to a plurality of timing points, state memory 102 stores the respective operation states of displays 100 included in network system 1A.

The recording medium implementing restoring procedure memory 101 or state memory 102 stores a program to be executed by control unit 110, data produced by execution of the program by control unit 110, and the like.

Control unit 110 is implemented by a processor such as a CPU (Central Processing Unit). Control unit 110 controls various portions of display 100 by executing the programs stored in the recording mediums. The programs in this description include, e.g., the programs that can be directly executed by the CPU as well as programs of a source program format, compression-processed programs, encrypted programs and the like.

Speaker 103 outputs a sound based on data provided from control unit 110. Thus, control unit 110 causes speaker 103 to output the sound (contents), based on the contents data provided from contents output device 400.

Display drive circuit 104 displays the picture on screen 105 based on the data provided from control unit 110. Thus, control unit 110 displays the picture (contents) on screen 105 by controlling display drive circuit 104 based on the contents data provided from contents output device 400.

Lamp state detecting circuit 106 is a circuit for detecting whether back light 109 is on or not. Lamp state detecting circuit 106 provides to control unit 110 a signal indicating whether back light 109 is on or off.

Communication interface 107 externally transmits and receives the data based on the data provided from control unit 110. Communication interface 107 according to the embodiment transmits and receives the data to/from other displays 100, management PC 500 and others over first network 51 based on a predetermined protocol.

Contents input interface 108 externally transmits and receives the data based on the data provided from control unit 110. Over second network 52, contents input interface 108 according to the embodiment receives the contents data from contents output device 400 and transmits a restart command to contents output device 400, based on the predetermined protocol.

Back light 109 emits light onto screen 105 from a rear side of screen 105, based on the signal provided from control unit 110.

Then, the function of control unit 110 will be described. Control unit 110 includes a state obtaining unit 111, a condition determining unit 112, a restoring processing unit 113 and an abnormality notifying unit 114. More specifically, state obtaining unit 111, condition determining unit 112, restoring processing unit 113 and abnormality notifying unit 114 may be modules that are implemented by control unit 110 executing the programs stored in the recording medium, or may be logic circuits of hardware, respectively.

State obtaining unit 111 obtains the operation state of the displays included in network system 1A. Periodically, or when the main power of display 100 is turned on, state obtaining unit 111 obtains through communication interface 107 the operation states of all the displays connected to display 100 in question.

State obtaining unit 111 periodically stores, in state memory 102, the operation states of all displays connected to display 100 in question. State obtaining unit 111 also stores periodically the operation state of display 100 in state memory 102.

Periodically, or when the main power of display 100 is turned on, condition determining unit 112 determines the operation state based on majority rule according to the operation states that correspond to all the displays and are stored in state memory 102. Thereby, it determines a standard operation state of network system 1A.

When a plurality of operation states each attained by most displays 100 are present, the condition determining unit may wait for a state in which there is only one operation state attained by most displays 100, or a standard operation state may be determined according to a priority order that is predetermined. For example, when there are two displays of which soft powers are on, respectively, and there are two displays of which soft powers are off, the state in which the soft power is on is handled as the standard state.

Condition determining unit 112 stores the standard operation state in state memory 102. Condition determining unit 112 determines whether all the items in the standard operation state match all the items in the operation state of display 100 or not. In other words, condition determining unit 112 determines whether the standard state differs in any item from the operation state of display 100 or not.

Any one of the displays may be in a transitory state, e.g., when the power in any one of the displays is changing from the off state to the on state. Therefore, condition determining unit 112 may refer to state memory 102, and thereby may determine whether the standard operation states corresponding to a certain number of times are the same as the operation state of display 100 or not. In this case, condition determining unit 112 determines a predetermined number of times or more whether the standard operation state is different from the operation state of display 100 or not. Condition determining unit 112 transfers a result of the determination to restoring processing unit 113.

When the standard operation state differs in a certain item from the operation state of display 100, restoring processing unit 113 reads out the corresponding program from restoring procedure memory 101, and executes the corresponding restoring processing so that the operation state of display 100 may match the operation states of the other displays.

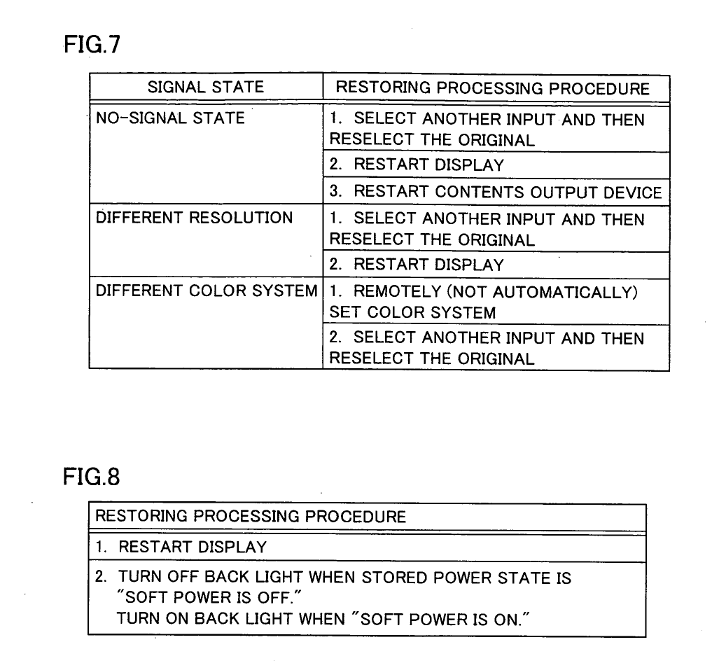

The program for the restoring processing will be described below. FIG. 7 is an image diagram showing the restoring processing executed in the signal state restoring processing. Referring to FIG. 7, restoring processing unit 113 successively reads out commands relating to the corresponding restoring processing from restoring procedure memory 101 and executes them.

For example, in the operation states of display 100, when the input terminal is different from the input terminal in the standard operation state, restoring processing unit 113 executes, as a first step (F=1), a command for selecting another input terminal and then reselecting the original input terminal. As a second step (F=2), restoring processing unit 113 executes a command for restarting display 100. As a third step (F=3) restoring processing unit 113 executes a command for restarting contents output device 400 through communication interface 107.

In the operation state of display 100, when a resolution differs from that in the standard operation state, restoring processing unit 113 executes, as a first step (F=1), a command for selecting another input terminal and then reselecting the original input terminal. Restoring processing unit 113 executes, as a second step (F=2), a command for restarting display 100.

In the operation state of display 100, when a color system differs from the color system in the standard operation state, restoring processing unit 113 executes, as a first step (F=1), a command for changing from automatic control to remote setting. As a second step (F=2), restoring processing unit 113 executes a command for selecting another input terminal and then reselecting the original input terminal.

FIG. 8 is an image diagram showing the restoring processing executed in the lamp state restoring processing. Referring to FIG. 8, restoring processing unit 113 successively reads commands relating to the corresponding restoring processing from the restoring procedure memory, and executes them.

For example, in the operation state of display 100, when the lamp state is different from that in the standard operation state, restoring processing unit 113 executes, as a first step (F=1), a command for restarting display 100. Restoring processing unit 113 executes, as a second step (F=2), a command for turning on the back light when the soft power of display 100 is on, and turning off the back light when the soft power of display 100 is off.

Returning to FIG. 6, after the restoring processing, condition determining unit 112 according to the embodiment determines again whether all the items in the standard operation state match all the items in the operation state of display 100 or not. In other words, condition determining unit 112 determines whether the standard operation state differs in any item from the operation state of display 100 or not.

When the standard operation state differs in any item from the operation state of display 100 after the restoring processing, abnormality notifying unit 114 provides management PC 500 a notification that the restoration cannot be performed, through communication interface 107.

<Determining Processing>

Various processing procedures in display 100 according to the embodiment will be described below. Various kinds of processing (steps) may be implemented by control unit 110 executing the programs, or various function blocks (state obtaining unit 111, condition determining unit 112, restoring processing unit 113 and abnormality notifying unit 114) may implement them by hardware circuits.

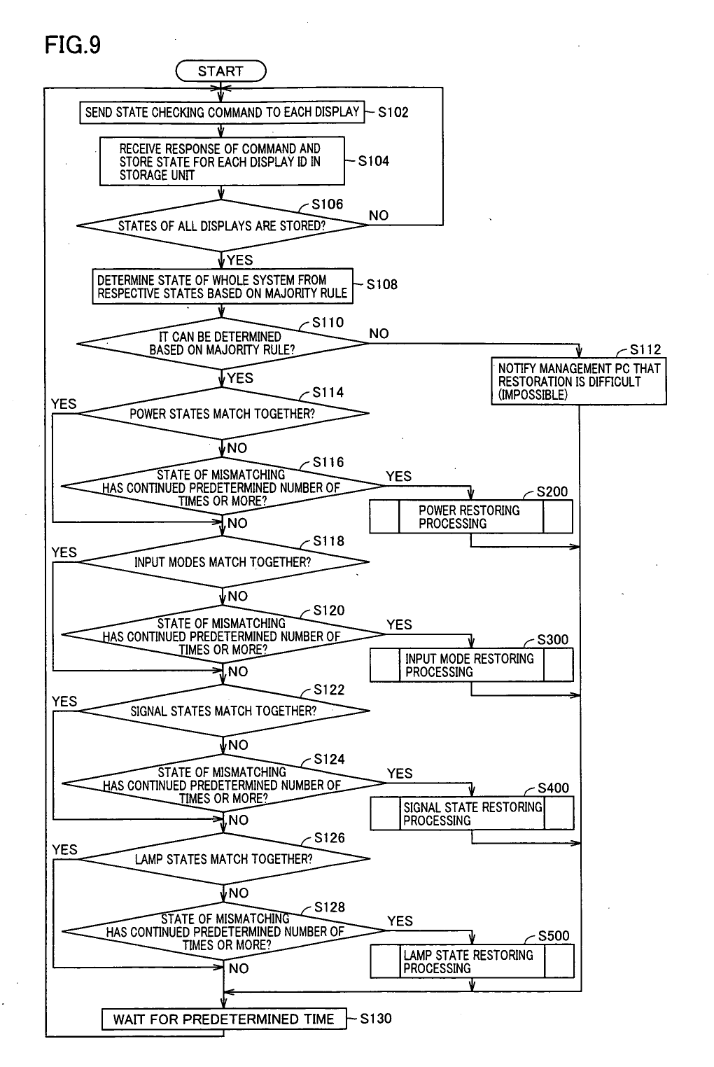

First, the processing procedure of the determining processing in display 100 according to the embodiment will be described. FIG. 9 is a flowchart showing the processing procedure of the determining processing in display 100 according to the embodiment.

Referring to FIG. 9, control unit 110 transmits a state checking command through communication interface 107 to the other displays included in network system 1A (step S102). Control unit 110 receives a response (operation state) from the other displays through communication interface 107. Control unit 110 stores the received operation state in state memory 102 together with information for identifying the other displays (step S104). In this operation, control unit 110 also stores the operation state of itself (display 100) in state memory 102.

Control unit 110 determines whether the operation states of all the displays included in network system 1A are already stored or not (step S106). When the operation states of all the displays included in network system 1A are not stored (NO in step S106), control unit 110 repeats the processing starting from step S102.

When the operation states of all the displays included in network system 1A are stored (YES in step S106), control unit 110 determines the standard operation state of network system 1A based on the majority rule relating to the operation state (step S108). Control unit 110 determines whether the standard operation state of network system 1A can be determined based on the majority rule or not (step S110).

When the standard operation state of network system 1A cannot be determined based on the majority rule (NO in step S110), control unit 110 transmits a message indicating that the restoration is difficult to management PC 500 through communication interface 107 (step S112). Control unit 110 executes the processing starting from a step S130.

When the standard operation state of network system 1A can be determined based on the majority rule (YES in step S110), control unit 110 determines whether the power state in the operation state of itself (display 100) matches the power state in the standard operation state of network system 1A or not (step S114). When the power state in the operation state of itself (display 100) matches the power state in the standard operation state of network system 1A (YES step S114), control unit 110 executes the processing starting from a step S118.

When the power state in the operation state of itself (display 100) does not match the power state in the standard operation state of network system 1A (NO step S114), control unit 110 determines whether the state of the above mismatching has continued at least a predetermined number of times or more, or not (step S116). When the state of the mismatching has continued the predetermined number of times or more (YES in step S116), control unit 110 executes the power restoring processing (step S200). The power restoring processing (step S200) will be described later. Control unit 110 executes the processing starting from step S130.

When the state of the mismatching has not continued the predetermined number of times or more (NO in step S116), control unit 110 determines whether the input mode (input terminal) in the operation state of itself (display 100) matches the input mode in the standard operation state of network system 1A or not (step S118). When the input mode (input terminal) in the operation state of itself (display 100) matches the input mode in the standard operation state of network system 1A (YES in step S118), control unit 110 executes the processing starting from a step S122.

When the input mode (input terminal) in the operation state of itself (display 100) does not match the input mode in the standard operation state of network system 1A (NO in step S118), control unit 110 determines whether the mismatching state has continued a predetermined number of time or more, or not (step S120). When the mismatching state has not continued the predetermined number of times or more (YES in step S120), control unit 110 executes the input mode restoring processing (step S300). The input mode restoring processing (step S300) will be described later. Control unit 110 executes the processing starting from step S130.

When the mismatching state has not continued the predetermined number of times or more (NO in step S120), control unit 110 determines whether the signal state in the operation state of itself (display 100) matches the signal state in the standard operation state of network system 1A or not (step S122). When the signal state in the operation state of itself (display 100) matches the signal state in the standard operation state of network system 1A (YES in step S122), control unit 110 executes the processing starting from a step S126.

When the signal state in the operation state of itself (display 100) does not match the signal state in the standard operation state of network system 1A (NO in step S122), control unit 110 determines whether the state of mismatching has continued a predetermined number of time or more, or not (step S124). When the mismatching state has continued the predetermined number of times or more (YES in step S124), control unit 110 executes the signal state restoring processing (S400). The signal state, restoring processing (step S400) will be described later. Control unit 110 executes the processing starting from step S130.

When the mismatching state has not continued the predetermined number of times or more (NO in step S124), control unit 110 determines whether the lamp state in the operation state of itself (display 100) matches the lamp state in the standard operation state of network system 1A or not (step S126). When the lamp state in the operation state of itself (display 100) matches the lamp state in the standard operation state of network system 1A (YES in step S126), control unit 110 executes the processing starting from step S130.

When the lamp state in the operation state of itself (display 100) does not match the lamp state in the standard operation state of network system 1A (NO in step S126), control unit 110 determines whether the state of mismatching has continued a predetermined number of times or more, or not (step S128). When the mismatching state has continued the predetermined number of times or more (YES in step S128), control unit 110 executes the lamp state restoring processing (step S500). The lamp state restoring processing will be described later (step S400). Control unit 110 executes the processing starting from step S130.

When the mismatching state has not continued the predetermined number of times or more (NO in step S128), control unit 110 repeats the processing starting from step S102 after keeping a waiting state for a predetermined time (step S130).

<Power Restoring Processing>

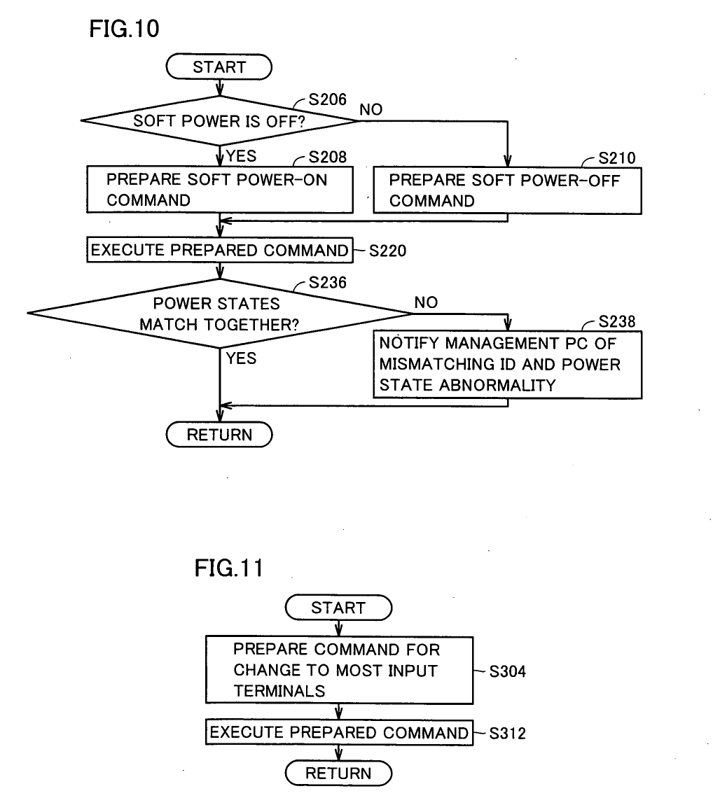

The processing procedure of the power restoring processing in display 100 according to the embodiment will be described below. Thus, description will be given on the processing in display 100 performed when the power state in the operation state of itself (display 100) is different from the power state in the standard operation state of network system 1A. FIG. 10 is a flowchart showing the processing procedure of the power restoring processing in display 100 according to the embodiment.

Referring to FIG. 10, control unit 110 determines whether the soft power in the operation state of itself (display 100) is off or not (step S206). When the soft power in the operation state of itself (display 100) is off (YES in step S206), control unit 110 prepares a command for turning on the soft power (step S208). Control unit 110 executes the processing starting from step S220.

When the soft power in the operation state of itself (display 100) is on (NO in step S206), control unit 110 prepares a command for turning off the soft power (step S210). Control unit 110 executes a prepared command (step S220).

Control unit 110 determines whether the power state in the operation state of itself (display 100) matches the power state in the standard operation state of network system 1A or not (step S236). When the power state in the operation state of itself (display 100) matches the power state in the standard operation state of network system 1A (YES in step S236), control unit 110 ends the power restoring processing.

When the power state in the operation state of itself (display 100) does not match the power state in the standard operation state of network system 1A (NO in step S236), control unit 110 transmits identification information of itself (display 100) and a message indicating that the power state is abnormal to management PC 500 through communication interface 107 (step S238). Control unit 110 ends the power restoring processing.

<Input Mode Restoring Processing>

The processing procedure of the input mode restoring processing in display 100 according to the embodiment will be described below. Thus, description will be given on the processing in display 100 performed when the input terminal in the operation state of itself (display 100) is different from the input terminal in the standard operation state of network system 1A. FIG. 11 is a flowchart showing the processing procedure of the input mode restoring processing in display 100 according to the embodiment.

Referring to FIG. 11, control unit 110 prepares a command for selecting the input terminal that is the same as that in the standard operation state (step S304). Control unit 110 executes the prepared command (step S312). Control unit 110 ends the input mode restoring processing.

<Signal State Restoring Processing>

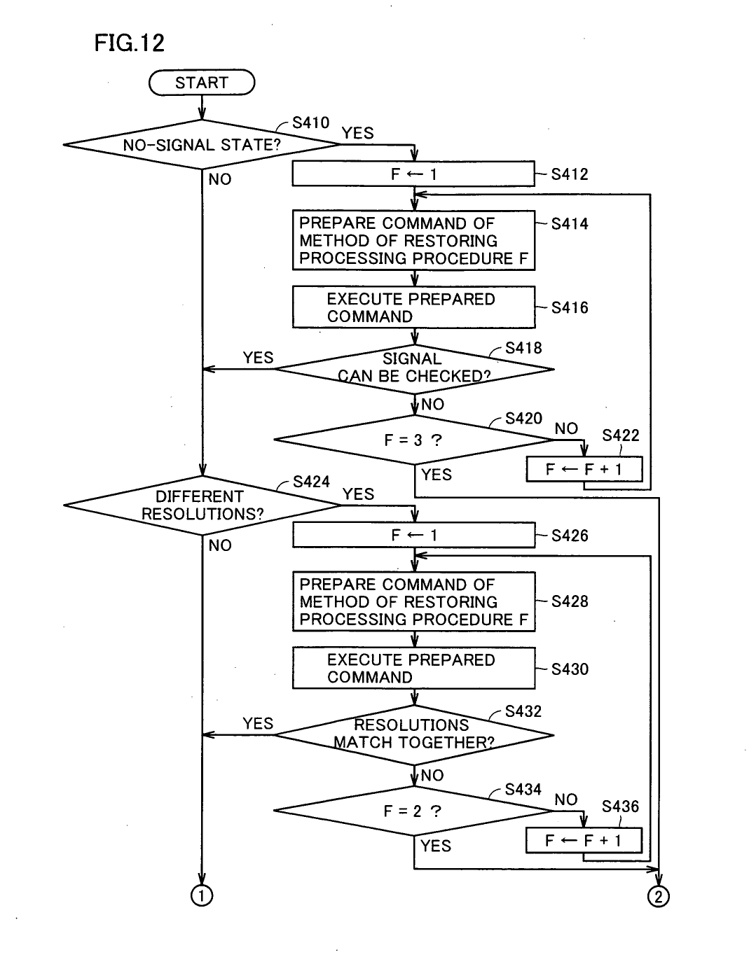

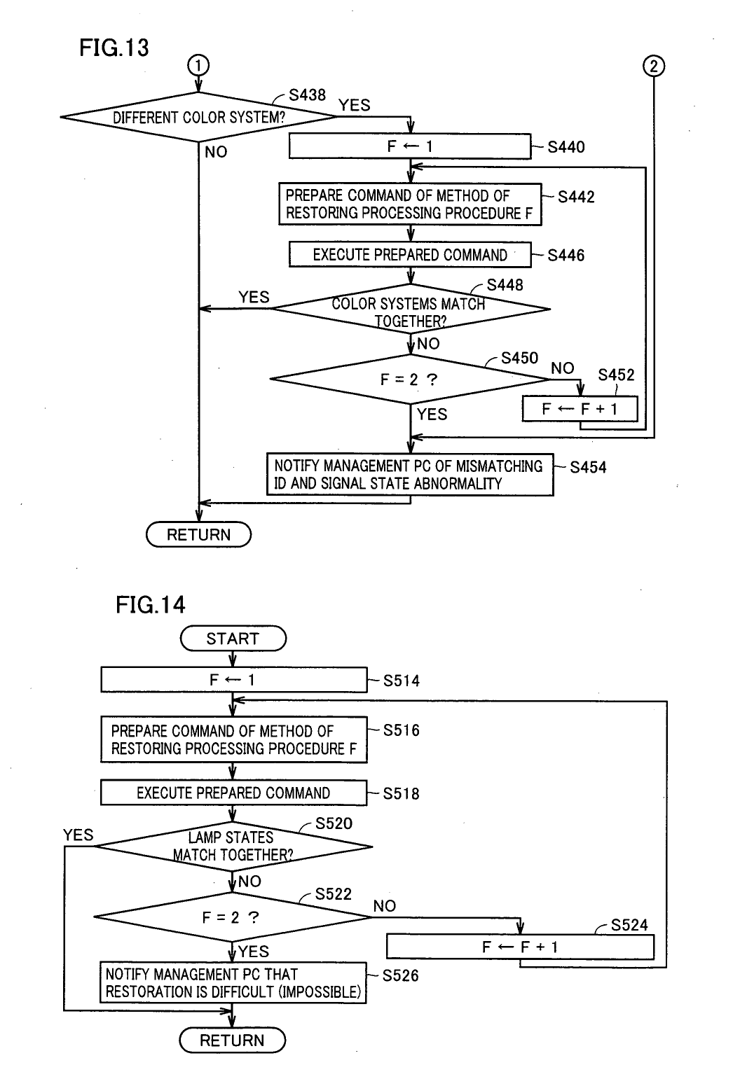

The processing procedure of the signal state restoring processing in display 100 according to the embodiment will be described below. Thus, description will be given on the processing of display 100 performed when the input signal state in the operation state of itself (display 100) is different from the input signal state in the standard operation state of network system 1A. FIG. 12 is a first flowchart showing the processing procedure of the signal state restoring processing in display 100 according to the embodiment. FIG. 13 is a second flowchart showing the processing procedure of the signal state restoring processing in display 100 according to the embodiment.

Referring to FIGS. 12 and 13, control unit 110 determines whether the presence/absence of the input signal in the operation state of itself (display 100) matches the presence/absence of the input signal in the standard operation state of network system 1A or not (step S410). For example, when the input signal is present according to the standard operation state of network system 1A, control unit 110 determines whether the operation state of itself (display 100) is the no-signal state or not.

When the operation state of itself (display 100) is the no-signal state (YES in step S410), control unit 110 substitutes 1 into a variable F of the recording medium (step S412). Control unit 110 reads out a command corresponding to variable F from restoring procedure memory 101 (step S414). Control unit 110 executes the prepared command (step S416).

Control unit 110 determines whether the presence/absence of the input signal in the operation state of itself (display 100) matches the presence/absence of the input signal in the standard operation state of network system 1A or not (step S418). When the presence/absence of the input signal in the operation state of itself (display 100) matches the presence/absence of the input signal in the standard operation state of network system 1A (YES in step S418), control unit 110 executes the processing starting from step S424.

When the presence/absence of the input signal in the operation state of itself (display 100) does not match the presence/absence of the input signal in the standard operation state of network system 1A (NO in step S418), control unit 110 determines whether F is equal to 3 (F=3) or not (step S420). When F is equal to 3 (YES in step S420), control unit 110 executes the processing starting from a step S454. When F is not equal to 3 (NO in step S420), control unit 110 increments variable F (step S422), and repeats the processing starting from step S414.

When the operation state of itself (display 100) is not the no-signal state (NO in step S410), control unit 110 determines whether the resolution corresponding to the input signal in the operation state of itself (display 100) is different from the resolution corresponding to the input signal in the standard operation state of network system 1A or not (step S424).

When the resolution in the operation state of itself (display 100) is different from the resolution in the standard operation state of network system 1A (YES in step S424), control unit 110 substitutes 1 into variable F of the recording medium (step S426). Control unit 110 reads the command corresponding to variable F from restoring procedure memory 101 (step S428). Control unit 110 executes the prepared command (step S430).

Control unit 110 determines whether the resolution in the operation state of itself (display 100) matches the resolution in the standard operation state of network system 1A or not (S432). When the resolution in the operation state of itself (display 100) matches the resolution in the standard operation state of network system 1A (YES in step S432), control unit 110 executes the processing starting from a step S438.

When the resolution in the operation state of itself (display 100) does not match the resolution in the standard operation state of network system 1A (NO in step S432), control unit 110 determines whether F is equal to 2 (F=2) or not (step S434). When F is equal to 2 (YES in step S434), control unit 110 executes processing starting from step S454. When F is not equal to 2 (NO in step S434), control unit 110 increments variable F (step S436), and repeats the processing starting from step S428.

When the resolution in the operation state of itself (display 100) matches the resolution in the standard operation state of network system 1A (NO in step S424), control unit 110 determines whether the color system in the operation state of itself (display 100) is different from the color system in the standard operation state of network system 1A or not (step S438).

When the color system in the operation state of itself (display 100) is different from the color system in the standard operation state of network system 1A (YES in step S438), control unit 110 substitutes 1 into variable F of the recording medium (step S440). Control unit 110 reads the command corresponding to variable F from restoring procedure memory 101 (step S442). Control unit 110 executes the prepared command (step S446).

Control unit 110 determines whether the color system in the operation state of itself (display 100) matches the color system in the standard operation state of network system 1A or not (step S448). When the color system in the operation state of itself (display 100) matches the color system in the standard operation state of network system 1A (YES in step S448), control unit 110 ends the signal state restoring processing.

When the color system in the operation state of itself (display 100) does not match the color system in the standard operation state of network system 1A (NO in step S448), control unit 110 determines whether F is equal to 2 (F=2) or not (step S450). When F is not equal to 2 (NO in step S450), control unit 110 increments variable F (step S452), and executes the processing starting from step S442.

When F is equal to 2 (YES in step S450), control unit 110 transmits the identification information of itself (display 100) and a message indicting that the signal state is abnormal to management PC 500 through communication interface 107 (step S454). Control unit 110 ends the signal state restoring processing.

<Lamp State Restoring Processing>

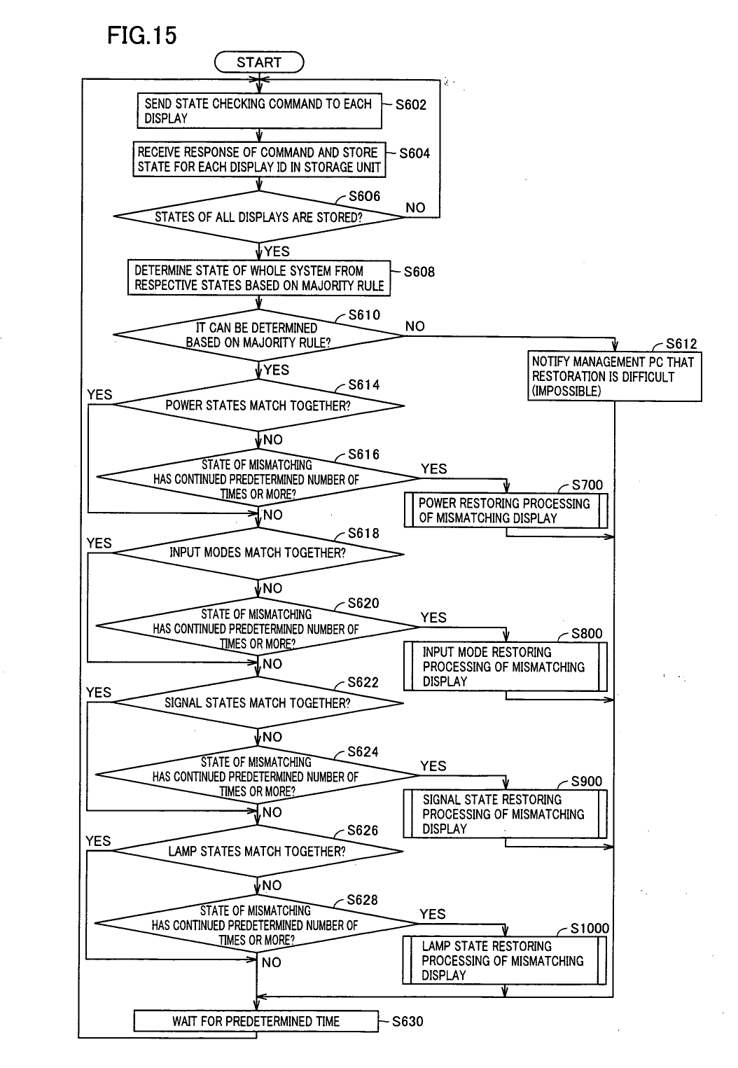

The processing procedure of the lamp state restoring processing in display 100 according to the embodiment will be described below. Thus, description will be given on the processing of display 100 performed in the case where the lamp state in the operation state of itself (display 100) is different from the lamp state in the standard operation state of network system 1A. FIG. 14 is a flowchart showing the processing procedure of the lamp state restoring processing in display 100 according to the embodiment.

Referring to FIG. 14, control unit 110 substitutes 1 into variable F of the recording medium (step S514). Control unit 110 reads a command corresponding to variable F from restoring procedure memory 101 (step S516). Control unit 110 executes the prepared command (step S518).

Control unit 110 determines whether the lamp state in the operation state of itself (display 100) matches the lamp state in the standard operation state of network system 1A or not (step S520). When the lamp state in the operation state of itself (display 100) matches the lamp state in the standard operation state of network system 1A (YES in step S520), control unit 110 ends the lamp state restoring processing.

When the lamp state in the operation state of itself (display 100) does not match the lamp state in the standard operation state of network system 1A (NO in step S520), control unit 110 determines whether F is equal to 2 (F=2) or not (step S522). When F is not equal to 2 (NO in step S522), control unit 110 increments variable F (step S524), and repeats the processing starting from step S516.

When F is equal to 2 (YES in step S522), control unit 110 transmits the identification information of itself (display 100) and a message indicating that the restoration is difficult to management PC 500 through communication interface 500 (step S526). Control unit 110 ends the lamp state restoring processing.

### Third Embodiment

A second embodiment of the invention will be described below. Network system 1A according to the first embodiment is configured such that each display 100 included in network system 1A determines whether the restoring processing is necessary or not. Conversely, a network system 1B according to the second embodiment is configured such that one display for management included in network system 1B determines whether the restoring processing of all the displays is necessary or not.

Description of substantially the same structure as network system 1B according to the first embodiment is not repeated.

<Whole Structure of Network System 1B>

Description will now be given on a whole structure of network system 1B according to the embodiment. FIG. 1 is an image diagram showing a whole structure of network system 1B according to the embodiment.

Referring to FIG. 1, network system 1B includes a management display 200A, a plurality of displays 200B, 200C and 200D, contents output device 400 and management PC 500. Management display 200A, each of the plurality of displays 200B, 200C and 200D, and management PC 500 perform mutual communications over first network 51. Management display 200A, each of the plurality of displays 200B, 200C and 200D, and contents output device 400 perform mutual communications over second network 52.

LCD or plasma televisions or the like implement management display 200A and the plurality of displays 200B, 200C and 200D, respectively. For example, a wired or wireless LAN, RS-232C, HDMI-CEC (High Definition Multimedia Interface-Consumer Electrons Control) or the like implements each of first and second networks 51 and 52.

However, management PC 500 and contents output device 400 may be the same device. First and second networks 51 and 52 may be the same network.

Network system 1B may include a plurality of contents output devices 400. In this case, management display 200A and the plurality of displays 200B, 200C and 200D receive different contents through a plurality of input terminals from the plurality of contents output devices 400, respectively.

Alternatively, contents output device 400 may output a plurality of contents through different output terminals, respectively. In this case, management display 200A and the plurality of displays 200B, 200C and 200D receive the different contents from the different output terminals of contents output device 400 through the plurality of input terminals, respectively.

Management display 200A and the plurality of displays 200B, 200C and 200D display the contents received from contents output device 400 through network 52. In this embodiment, management display 200A and the plurality of displays 200B, 200C and 200D receive the same contents from contents output device 400, and display the same contents.

<Operation Summary 1 of Network System 1B>

Description will now be given on the operation summary of network system 1B according to the embodiment.

The following description will be given on the case in which a soft-power of display 200B is off, and soft-powers of other displays 200A, 200C and 200D are on as shown in FIG. 2(A). The state in which the soft-power-is off means a so-called standby state in which a main power is on and a sub-power is off.

Periodically, or when the main power is turned on, management display 200A obtains the operation state from each of other displays 200B, 200C and 200D. Based on the operation states of displays 200A, 200B, 200C and 200D, management display 200A determines whether the operation state of display 200B is different from those of other displays 200A, 200C and 200D, or not. Thus, management display 200A determines whether displays 200A, 200C and 200D are in the soft-power off state or not.

When the operation state of display 200B is different from those of other displays 200A, 200C and 200D, i.e., when the soft-powers of other displays 200A, 200C and 200D are off, management display 200A transmits a command to display 200B and thereby causes display 200B to turn on the soft-power. Thus, as shown in FIG. 2(B), the soft powers of all displays 200A, 200B, 200C and 200D are turned on.

More specifically, management display 200A causes each of displays 200A, 200B, 200C and 200D to attain the operation state to which the most displays belong, based on the operation states of respective displays 200A, 200B, 200C and 200D.

As described above, all displays 200A, 200B, 200C and 200D in network system 1B according to the embodiment automatically attain the same operation state.

<Operation Summary 2 of Network System 1B>

Description will be given on the case in which display 200B display 200A displays first contents received through the DVI (Digital Visual Interface) terminal, and other displays 200A, 200C and 200D display second contents received through the HDMI terminals, as shown in FIG. 3(A).

Periodically, or when the main power is turned on, management display 200A obtains the operation state from each of other displays 200B, 200C and 200D. Based on the operation states of displays 200A, 200B, 200C and 200D, management display 200A determines whether the operation state of display 200B is different from those of other displays 200A, 200C and 200D or not. Thus, management display 200A determines whether other displays 200A, 200C and 200D are displaying the contents received through the DVI terminals or not.

When the operation state of display 200B is different from those of other displays 200A, 200C and 200D, i.e., when displays 200A, 200C and 200D are displaying the contents received through the HDMI terminals, management display 200A transmits a command to display 200B so that display 200B changes the input terminal to the HDMI terminal. Thus, as shown in FIG. 3(B), all displays 200A, 200B, 200C and 200D display the contents received through the HDMI terminals.

More specifically, management display 200A causes each of displays 200A, 200B, 200C and 200D to attain the operation state to which the most displays belong, based on the operation states of respective displays 200A, 200B, 200C and 200D.

In network system 1B according to the embodiment, as described above, all displays 200A, 200B, 200C and 200D automatically attain the same operation state.

<Operation Summary 3 of Network System 1B>

Description will now be given on the case where management display 200B has not received the signal from contents output device 400, and other displays 200A, 200C and 200D are receiving the signals in the format of 480p, as shown in FIG. 4(A).

Periodically, or when the main power is turned on, management display 200A obtains the operation state from each of other displays 200B, 200C and 200D. Based on the operation states of displays 200A, 200B, 200C and 200D, management display 200A determines whether the operation state of display 200B is different from those of other displays 200A, 200C and 200D or not. Thus, management display 200A determines whether other displays 200A, 200C and 200D are not receiving the signal or not.

When the operation state of display 200B is different from those of other displays 200A, 200C and 200D, i.e., when other displays 200A, 200C and 200D are receiving the 480p signal, management display 200A transmits a command to display to cause display 200B to restart display 200B. As shown in FIG. 4(B), however, display 200B does not receive the signal of the 480p format in some cases even after display 200B restarted.

In this case, management display 200A restarts contents output device 400. Thereby, as shown in FIG. 4(C), all displays 200A, 200B, 200C and 200D enter the state of receiving the signals of the 480p format from contents output device 400.

More specifically, management display 200A causes each of displays 200A, 200B, 200C and 200D to attain the operation state to which the most displays belong, based on the operation states of respective displays 200A, 200B, 200C and 200D.

In network system 1B according to the embodiment, as described above, all displays 200A, 200B, 200C and 200D automatically attain the same operation state.

<Operation Summary 4 of Network System 1B>

Description will now be given on the case where a back light of display 200B is off, and back lights of other displays 200A, 200C and 200D are on, as shown in FIG. 5(A).

Periodically, or when the main power is turned on, management display 200A obtains the operation state from each of other displays 200A, 200C and 200D. Based on the operation states of displays 200A, 200B, 200C and 200D, management display 200A determines whether the operation state of display 200B is different from those of other displays 200A, 200C and 200D or not. Thus, management display 200A determines whether the back lights of other displays 200B, 200C and 200D are off or not.

When the operation state of display 200B is different from those of other displays 200A, 200C and 200D, i.e., when the back light of other displays 200A, 200C and 200D are on, management display 200A transmits a command to display 200B and thereby causes display 200B to turn on the back light. Thus, as shown in FIG. 5(B), all displays 200A, 200B, 200C and 200D turn on the back lights.

More specifically, management display 200A causes each of displays 200A, 200B, 200C and 200D to attain the operation state to which the most displays belong, based on the operation states of respective displays 200A, 200B, 200C and 200D.

In network system 1B according to the embodiment, as described above, all displays 200A, 200B, 200C and 200D automatically attain the same operation state.

Description will now be given on the structure of network system 1B for implementing the above functions. In the following description, displays 200A, 200B, 200C and 200D may be generally referred to as displays 200.

<Structure of Management Display 200A>

A form of a specific structure of management display 200A according to the embodiment will be described below. Referring to FIG. 6, management display 200A includes, as major components, control unit 110, restoring procedure memory 101, state memory 102, speaker 103, display drive circuit 104, screen 105, lamp state detecting circuit 106, communication interface 107, contents input interface 108 and back light 109.

The hardware structure according to the embodiment is substantially the same as that of display 100 according to the first embodiment so that description thereof is not repeated. The function of control unit 110 will be described below.

Control unit 110 includes state obtaining unit 111, condition determining unit 112, restoring processing unit 113 and abnormality notifying unit 114. More specifically, state obtaining unit 111, condition determining unit 112, restoring processing unit 113 and abnormality notifying unit 114 may be modules that are implemented by control unit 110 executing the programs stored in the recording medium, or may be logic circuits of hardware, respectively.

State obtaining unit 111 obtains the operation state of displays 200 included in network system 1B. Periodically, or when the main power of management display 200A is turned on, state obtaining unit 111 obtains the operation states of all the displays connected to management display 200A through communication interface 107 from all the displays connected to management display 200A.

State obtaining unit 111 periodically stores, in state memory 102, the operation states of all displays 200 connected to management display 200A. State obtaining unit 111 also stores periodically the operation state of management display 200A in state memory 102.

Periodically, or when the main power of management display 200A is turned on, condition determining unit 112 determines the operation state based on majority rule according to the operation states that correspond to all the displays and are stored in state memory 102. Thereby, it determines a standard operation state of network system 1B.

When a plurality of operation states each attained by most displays 200 are present, the condition determining unit may wait for a state in which there is only one operation state attained by most displays 200, or a standard operation state may be determined according to a priority order that is predetermined. For example, when there are two displays of which soft powers are on, respectively, and there are two displays of which soft powers are off, the state in which the soft power is on is handled as the standard state.

Condition determining unit 112 stores the standard operation state in state memory 102. Condition determining unit 112 determines whether all the items in the standard operation state match all the items in the operation state of each display 200 included in network system 200 or not.

Any one of the displays may be in a transitory state, e.g., when the power in any one of the displays is changing from the off state to the on state. Therefore, condition determining unit 112 may refer to state memory 102, and thereby may determine whether the standard operation states corresponding to a certain number of times are the same as the operation state of each display 200 or not. In this case, condition determining unit 112 determines a predetermined number of times or more whether the standard operation state is different from the operation state of each display 200 or not. Condition determining unit 112 transfers a result of the determination to restoring processing unit 113.

When the standard operation state differs in a certain item from the operation state of each display 200, restoring processing unit 113 reads out the corresponding program from restoring procedure memory 101, and transmits through communication interface 107 a command for causing each display 200 to perform the restoring processing so that the operation state of each display 200 may match the operation states of the other displays.

The program for the restoring processing is substantially the same as that of the first embodiment, and therefore description thereof is not repeated.

After the restoring processing, condition determining unit 112 according to the embodiment determines whether all the items in the standard operation state match all the items in the operation state of each display 200 or not. In other words, condition determining unit 112 determines whether the standard operation state differs in any item from the operation state of each display 200 or not.

When the standard operation state differs in any item from the operation state of each display 200 after the restoring processing, abnormality notifying unit 114 provides a notification that the restoration cannot be performed, to management PC 500 through communication interface 107.

<Structure of Displays 200B, 200C and 200D>

Each of displays 200B, 200C and 200D except for management display 200A differs from management display 200A in that control unit 110 does not have state obtaining unit 111, condition determining unit 112, abnormality notifying unit 114 and state memory 102. Display 200B may not have restoring procedure memory 101. In this case, restoring processing unit 113 of display 200B executes the restoring processing by receiving the control program (command) for the restoration from management display 200A.

Alternatively, restoring processing unit 113 of display 200B may receive the identification information of the command from management display 200A. In this case, restoring processing unit 113 of display 200B executes the restoring processing by referring to restoring procedure memory 101.

Other structures of display 200B are substantially the same as those of management display 200A, and therefore description thereof is not repeated.

<Determination Processing>

Various processing procedures in management display 200A according to the embodiment will be described below. Various kinds of processing (steps) may be implemented by control unit 110 executing the programs, or various function blocks (state obtaining unit 111, condition determining unit 112, restoring processing unit 113 and abnormality notifying unit 114) may implement them by hardware circuits.

First, the processing procedure of the determining processing in management display 200A according to the embodiment will be described. FIG. 15 is a flowchart showing the processing procedure of the determining processing in management display 200A according to the embodiment.

Referring to FIG. 15, control unit 110 transmits a state checking command through communication interface 107 to the other displays included in network system 1B (step S602). Control unit 110 receives a response (operation state) from the other displays through communication interface 107. Control unit 110 stores the received operation state in state memory 102 together with information for identifying the other displays (step S604). In this operation, control unit 110 also stores the operation state of itself (management display 200A) in state memory 102.

Control unit 110 determines whether the operation states of all displays 200 included in network system 1B are stored or not (step S606). When the operation states of all displays 200 included in network system 1B are not stored (NO in step S606), control unit 110 repeats the processing starting from step S602.

When the operation states of all displays 200 included in network system 1B are stored (YES in step S606), control unit 110 determine the standard operation state of network system 1B based on the majority rule relating to the operation state (step S606). Control unit 110 determines whether the standard operation state of network system 1B can be determined based on the majority rule or not (step S610).

When the standard operation state of network system 1B cannot be determined based on the majority rule (NO in step S610), control unit 110 transmits a message indicating that the restoration is difficult, to management PC 500 through communication interface 107 (step S612). Control unit 110 executes the processing starting from a step S630.

When the standard operation state of network system 1B can be determined based on the majority rule (YES in step S610), control unit 110 determines whether the power state in the operation state of each display 200 matches the power state in the standard operation state of network system 1B or not (step S614). When the power state in the operation state of each display 200 matches the power state in the standard operation state of network system 1B (YES in step S614), the processing starting from step S618 is executed.

When the power state in the operation state of each display 200 matches the power state in the standard operation state of network system 1B (NO in step S614), control unit 110 determines whether the state or mismatching has continued a predetermined number of times or more, or not (step S616). When the state of mismatching has continued the predetermined number of times or more (YES in step S616), control unit 110 executes the power restoring processing (step S700) of display 200 of which power state does not match the power state in the standard operation state of network system 1B. The power restoring processing (step S700) will be described later. Control unit 110 executes the processing starting from step S630.

When the state mismatching has not continued the predetermined number of times or more (NO in step S616), control unit 110 determines whether the input mode (input terminal) in the operation state of each display 200 matches the input mode in the standard operation state of network system 1B or not (step S618). When the input mode (input terminal) in the operation state of each display 200 matches the input mode in the standard operation state of network system 1B (YES in step S618), control unit 110 executes the processing starting from a step S622.

When the input mode (input terminal) in the operation state of each display 200 does not match the input mode in the standard operation state of network system 1B (NO in step S618), control unit 110 determines whether the state of mismatching has continued a predetermined number of times or more, or not (step S620). When the state of mismatching has continued the predetermined number of times or more (YES in step S620), control unit 110 executes the input mode restoring processing (step S800) of display 200 that is in the input mode not matching the input mode in the standard operation state of network system 1B. The input mode restoring processing (step S800) will be described later. Control unit 110 executes the processing starting from step S630.

When the state of mismatching has not continued the predetermined number of times or more (NO in step S620), control unit 110 determines whether the signal state in the operation state of each display 200 matches the signal state in the standard operation state of network system 1B or not (step S622). When the signal state in the operation state of each display 200 matches the signal state in the standard operation state of network system 1B (YES in step S622), control unit 110 executes the processing starting from step S626.

When the signal state in the operation state of each display 200 does not match the signal state in the standard operation state of network system 1B (NO in step S622), control unit 110 determines whether the state of mismatching has continued a predetermined number of times or more, or not (step S624). When the state of mismatching has continued the predetermined number of times (YES in step S624), control unit 110 executes the signal state restoring processing (step S900) of display 200 that is in the signal state not matching with the signal state in the standard operation state of network system 1B (step S900). The signal state restoring processing (step S900) will be described later. Control unit 110 executes the processing starting from step S630.

When the state of mismatching has not continued the predetermined number of times or more (NO in step S624), control unit 110 determines (step S626) whether the lamp state in the operation state of each display 200 matches the lamp state in the standard operation state of network system 1B or not (step S626). When the lamp state in the operation state of each display 200 matches the lamp state in the standard operation state of network system 1B (YES in step S626), control unit 110 executes the processing starting from step S630.

When the lamp state in the operation state of each display 200 does not match the lamp state in the standard operation state of network system 1B (NO in step S626), control unit 110 determines whether the state of mismatching has continued a predetermined number of times or more, or not (step S628). When the state of mismatching has not continued the predetermined number of times or more (YES in step S628), control unit 110 executes the lamp state restoring processing (step S500). The lamp state restoring processing (S400) will be described later. Control unit 110 executes the processing starting from a step S630.

When the state of mismatching has not continued the predetermined number of times or more (NO in step S628), control unit 110 repeats the processing starting from step S602 after keeping a waiting state for a predetermined time (step S630).

<Power Restoring Processing>

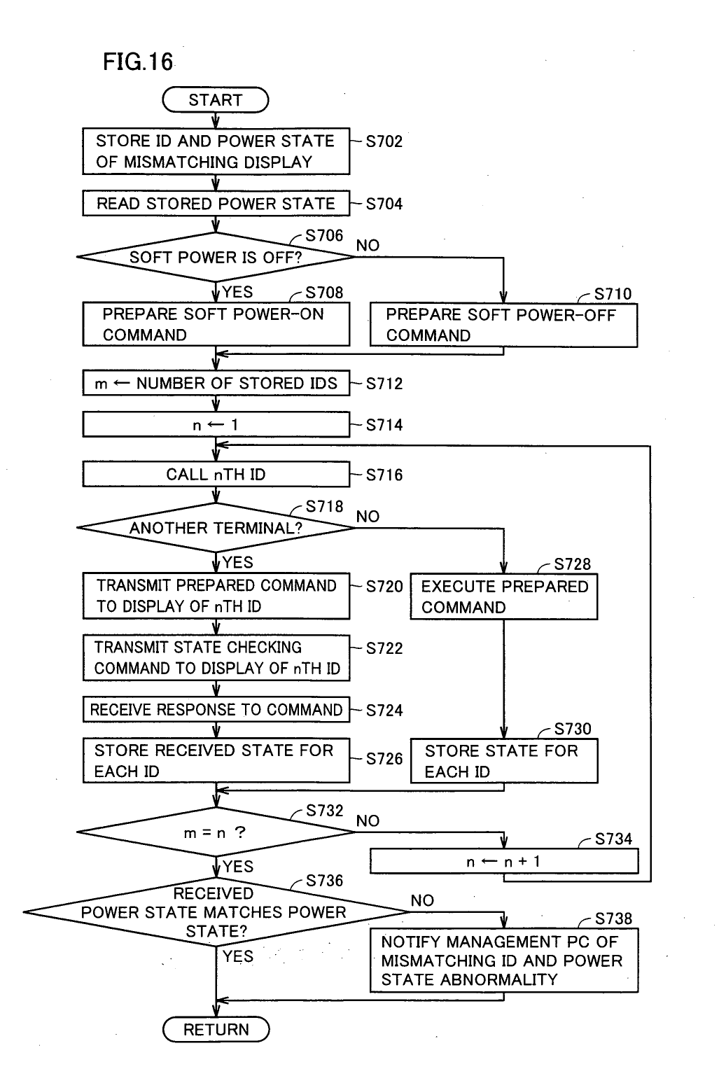

The processing procedure of the power restoring processing in management display 200A according to the embodiment will be described below. Thus, description will be given on the processing in management display 200A performed when the power state in the operation state of each display 200 is different from the power state in the standard operation state of network system 1B. FIG. 16 is a flowchart showing the processing procedure of the power restoring processing in management display 200A according to the embodiment.

Referring to FIG. 16, control unit 110 stores, in state memory 102, the identification information and the power state of display 200 of which power state does not match the power state in the standard operation state of network system 1B (step S702). Control unit 110 reads out from state memory 102 the power state of display 200 not matching the power state in the standard operation state of network system 1B (step S704). Control unit 110 determines whether the soft power in the operation state of such mismatching display 200 is off or not (step S706).

When the soft power in the operation state of mismatching display 200 is off (YES in step S706), control unit 110 prepares a command for turning on the soft power (step S708). Control unit 110 executes the processing starting from step S712.

When the soft power in the operation state of mismatching display 200 is on (NO in step S706), control unit 110 prepares a command for turning off the soft power (step S710). Control unit 110 substitutes the number of items of the identification information stored in state memory 102 into a variable m (step S712). Control unit 110 substitutes 1 into a variable n (step S714).

Control unit 110 reads out the identification information of display 200 corresponding to variable n (step S716). Control unit 110 determines whether display 200 corresponding to variable n is a display other than management display 200A or not (step S718). When display 200 corresponding to variable n is a display other than management display 200A (YES in step S718), control unit 110 transmits a prepared command to display 200 corresponding to variable n through communication interface 107 based on the identification information of display 200 in question (step S720).

Control unit 110 transmits a state checking command to display 200 in question through communication interface 107 (step S722). Control unit 110 receives a response (operation state) from display 200 in question through communication interface 107 (step S724). Control unit 110 stores the received operation state in state memory 102 together with a correspondence with the identification information of display 200 in question (step S726). Control unit 110 executes the processing starting from a step S732.

Conversely, when display 200 corresponding to variable n is management display 200A (NO in step S718), control unit 110 executes a prepared command (step S728). Control unit 110 stores the operation state of management display 200A together with the identification information of management display 200A (step S730).

Control unit 110 determines whether variable m is equal to n (m=n) or not (step S732). When variable m is not equal to n (NO in step S732), control unit 110 increments variable n (step S734), and repeats the processing starting from step S716.

When variable m is equal to n (YES in step S732), control unit 110 determines whether the power state in a new operation state matches the power state in the standard operation state or not (step S736). When the power state in the new operation state matches the power state in the standard operation state (YES in step S736), the power restoring processing ends.

When the power state in the new operation state does not match the power state in the standard operation state (NO in step S736), control unit 110 transmits the identification information of display 200 that is still in the mismatching power state as well as a message indicating that the power stat is abnormal to management PC 500 through communication interface 107 (step S738). Control unit 110 ends the power restoring processing.

<Input Mode Restoring Processing>

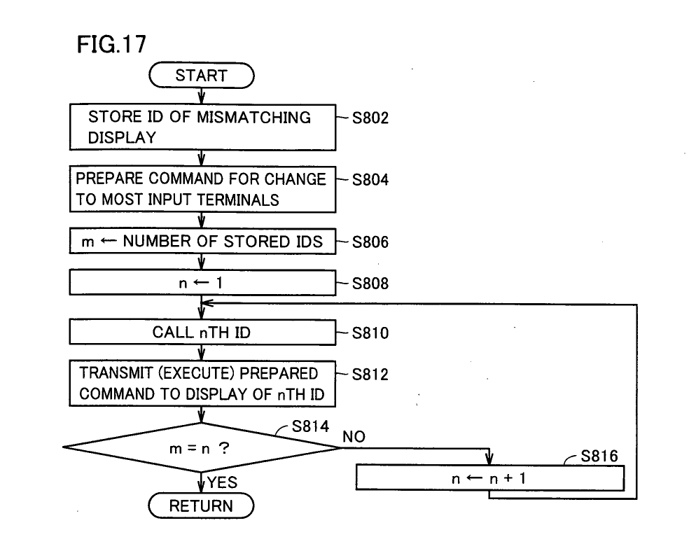

The processing procedure of the input mode restoring processing in management display 200A according to the embodiment will be described below. Thus, description will be given on the processing in management display 200A performed when the input terminal in the operation state of each display 200 is different from the input terminal in the standard operation state of network system 1B. FIG. 17 is a flowchart showing the processing procedure of the input mode restoring processing in management display 200A according to the embodiment.

Referring to FIG. 17, control unit 110 stores, in state memory 102, the input terminal and the identification information of display 200 of which input terminal does not match the input terminal in the standard operation state of network system 1B (step S802). Control unit 110 prepares a command for selecting the input terminal that is the same as that in the standard operation state (step S804). Control unit 110 substitutes the number of the identification information items stored in state memory 102 into variable m (step S806). Control unit 110 substitutes 1 into variable n (step S808).

Control unit 110 reads out the identification information of display 200 corresponding to variable n (step S810). Based on the identification information of display 200 corresponding to variable n, control unit 110 transmits the prepared command to display 200 in question through communication interface 107 (step S812). However, when variable n corresponds to management display 200A, the command prepared by control unit 110 is executed.

Control unit 110 determines whether variable m is equal to n (m=n) or not (step S814). When variable m is not equal to n (NO in step S814), control unit 110 increments variable n (step S816), and repeats the processing starting from step S810.

When variable m is equal to n (YES in step S814), control unit 110 ends the input mode restoring processing.

In the input mode restoring processing, control unit 110 may transmit the state checking command to display 200 corresponding to variable n through communication interface 107 after step S812, similarly to the power state restoring processing. Control unit 110 receives a response (operation state) from display 200 in question through communication interface 107. Control unit 110 stores the received operation state in state memory 102. Alternatively, control unit 110 stores the operation state of management display 200A together with the identification information of management display 200A.

In the case of YES in step S814, control unit 110 determines whether the new operation state matches the standard operation state or not. When the new operation state matches the standard operation state, the input mode restoring processing ends. When the new operation state does not match the standard operation state, control unit 110 transmits the identification information of display 200 that is still in the mismatching power state as well as a message indicating that the power state is abnormal to management PC 500 through communication interface 107.

<Signal State Restoring Processing>

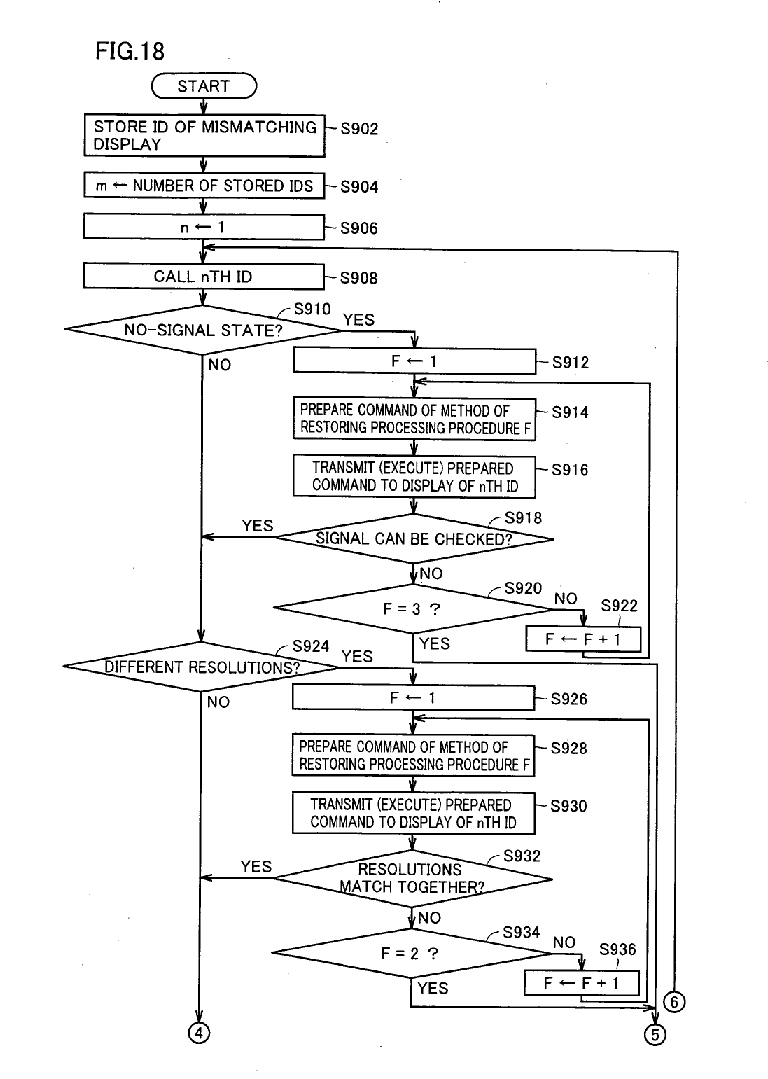

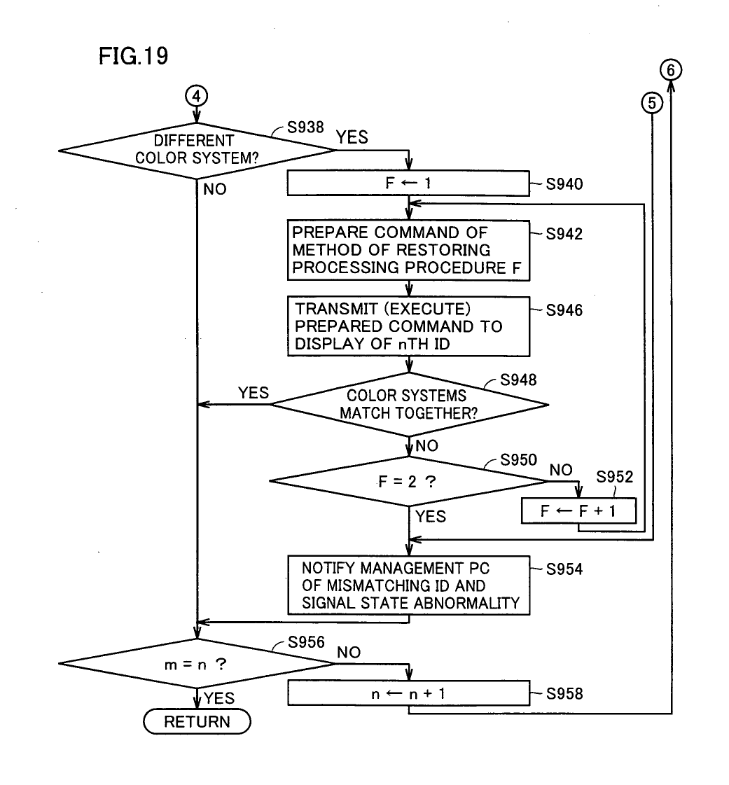

The processing procedure of the signal state restoring processing in management display 200A according to the embodiment will be described below. Thus, description will be given on the processing of management display 200A performed when the input signal state in the operation state of each display 200 is different from the input signal state in the standard operation state of network system 1B. FIG. 18 is a first flowchart showing the processing procedure of the signal state restoring processing in management display 200A according to the embodiment. FIG. 19 is a second flowchart showing the processing procedure of the signal state restoring processing in management display 200A according to the embodiment.

Referring to FIGS. 18 and 19, control unit 110 stores, in state memory 102, the identification information and the signal state of display 200 of which signal state does not match the signal state in the standard operation state of network system 1B. Control unit 110 substitutes the number of the identification information items stored in state memory 102 into variable m (step S904). Control unit 110 substitutes 1 into variable n (step S906).

Control unit 110 reads out the identification information of display 200 corresponding to variable n (step S908). Control unit 110 determines whether the presence/absence of the input signal in the operation state of display 200 corresponding to variable n matches the presence/absence of the input signal in the standard operation state of network system 1B or not (step S910). For example, when the input signal is present according o the standard operation state, control unit 110 determines whether the operation state of display 200 corresponding to variable n is the no-signal state or not.

When the operation state of display 200 corresponding to variable n is the no-signal state (YES in step S910), control unit 110 substitutes 1 into variable F of the recording medium (step S912). Control unit 110 reads the command corresponding to variable F from restoring procedure memory 101 (step S914). Control unit 110 transmits the prepared command to display 200 corresponding to variable n through communication interface 107 (step S916). However, when variable n corresponds to management display 200A, control unit 110 executes the command prepared by control unit 110.

Control unit 110 determines whether the presence/absence of the input signal in the operation state of display 200 corresponding to variable n matches the presence/absence of the input signal in the standard operation state of network system 1B or not (step S918). When the presence/absence of the input signal in the operation state of display 200 corresponding to variable n matches the presence/absence of the input signal in the standard operation state of network system 1B (YES in step S918), control unit 110 executes the processing starting from a step S924.

When the presence/absence of the input signal in the operation state of display 200 corresponding to variable n does not match the presence/absence of the input signal in the standard operation state of network system 1B (NO in step S918), control unit 110 determines whether F is equal to 3 or not (step S920). When F is equal to 3 (YES in step S920), control unit 110 executes the processing starting from a step S954. When F is not equal to 3 (NO in step S920), control unit 110 increments variable F (step S922), and repeats the processing starting from step S914.

When the operation state of display 200 corresponding to variable n is not the no-signal state (NO in step S910), control unit 110 determines whether the resolution corresponding to the input signal in the operation state of display 200 corresponding to variable n is different from the resolution corresponding to the input signal in the standard operation state of network system 1B, not (step S924).

When the resolution in the operation state of display 200 corresponding to variable n is different from the resolution in the standard operation state of network system 1B (YES in step S924), control unit 110 substitutes 1 into variable F of the recording medium (step S926). Control unit 110 reads out a command corresponding to variable F from restoring procedure memory 101 (step S928). Control unit 110 transmits the prepared command to display 200 corresponding to variable n through communication interface 107 (step S930). However, when variable n corresponds to management display 200A, control unit 110 executes the prepared command.

Control unit 110 determines whether the resolution in the operation state of display 200 corresponding to variable n matches the resolution in the standard operation state of network system 1B or not (step S932). When the resolution in the operation state of display 200 corresponding to variable n matches the resolution in the standard operation state of network system 1B (YES in step S932), control unit 110 executes the processing starting from a step S938.

When the resolution in the operation state of display 200 corresponding to variable n does not match the resolution in the standard operation state of network system 1B (NO in step S932), control unit 110 determines whether F is equal to 2 or not (step S934). When F is equal to 2 (YES in step S934), control unit 110 executes the processing starting from step S954. When F is not equal to 2 (NO in step S934), control unit 110 increments variable F (step S936), and repeats the processing starting from step S928.

When the resolution in the operation state of display 200 corresponding to variable n matches the resolution in the standard operation state of network system 1B (NO in step S924), control unit 110 determines whether the color system in the operation state of display 200 corresponding to variable n is different from the color system in the standard operation state of network system 1B or not (step S938).

When the color system in the operation state of display 200 corresponding to variable n is different from the color system in the standard operation state of network system 1B (YES in step S938), control unit 110 substitutes 1 into variable F of the recording medium (step S940). Control unit 110 reads out a command corresponding to variable F from restoring procedure memory 101 (step S942). Control unit 110 transmits the prepared command to display 200 corresponding to variable n through communication interface 107 (step S946). However, when variable n corresponds to management display 200A, control unit 110 executes the prepared command.

Control unit 110 determines whether the color system in the operation state of display 200 corresponding to variable n matches the color system in the standard operation state of network system 1B or not (step S948). When the color system in the operation state of display 200 corresponding to variable n matches the color system in the standard operation state of network system 1B (YES in step S948), control unit 110 executes the processing starting from step S956.

When the color system in the operation state of display 200 corresponding to variable n does not match the color system in the standard operation state of network system 1B (NO in step S948), control unit 110 determines whether F is equal to 2 or not (step S950). When F is not equal to 2 (NO in step S950), control unit 110 increments variable F (step S952), and executes the processing starting from step S942.

When F is equal to 2 (YES in step S950), control unit 110 transmits the identification information of display 200 corresponding to variable n and a message indicating that the signal state is abnormal to management PC 500 through communication interface 107 (step S954). Control unit 110 determines whether variable m is equal to n or not (step S956). When m is not equal to n (NO in step S956), control unit 110 increments variable n (step S958), and repeats the processing starting from step S908.

When variable m is equal to n (YES in step S956), control unit 110 ends the signal state restoring processing.

<Lamp State Restoring Processing>

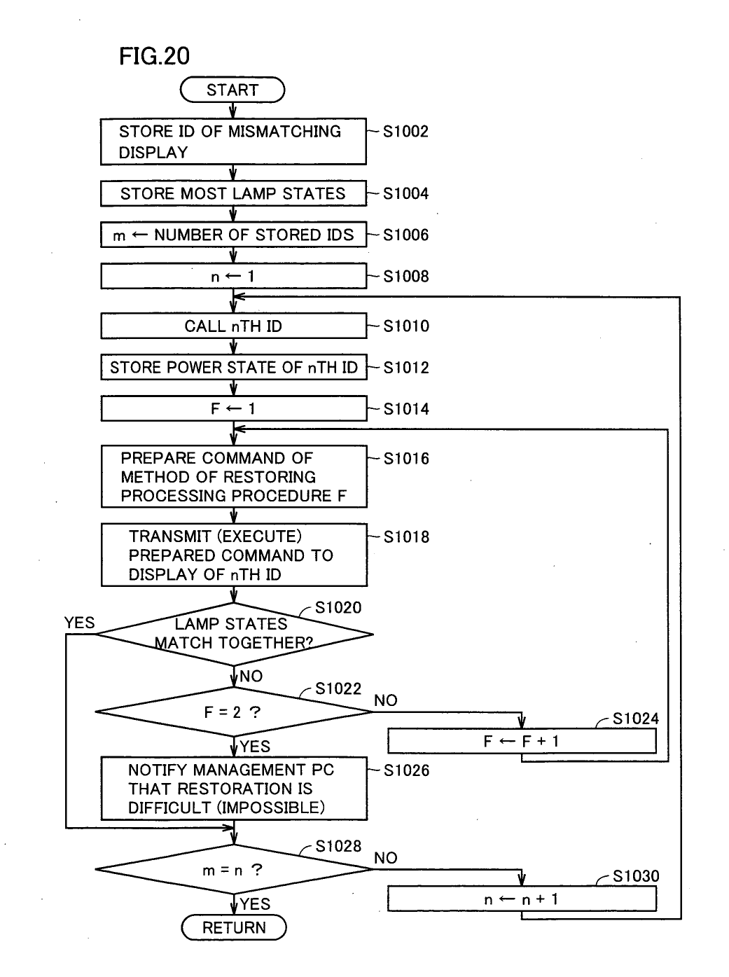

The processing procedure of the lamp state restoring processing in management display 200A according to the embodiment will be described below. Thus, description will be given on the processing performed by management display 200A when the lamp state in the operation state of each display 200 is different from the lamp state in the standard operation state of network system 1B. FIG. 20 is a flowchart showing the processing procedure of the lamp state restoring processing in management display 200A according to the embodiment.

Referring to FIG. 20, control unit 110 stores, in state memory 102, the identification information and the lamp state of display 200 of which lamp state does not match the lamp state in the standard operation state of network system 1B (step S1002). Control unit 110 stores the lamp state in the standard operation state in state memory 102 (step S1004). Control unit 110 substitutes the number of the identification information items stored in state memory 102 into variable m (step S1006). Control unit 110 substitutes 1 into variable n (step S1008).

Control unit 110 reads the identification information of display 200 corresponding to variable n (step S1010). Control unit 110 stores the power state of display 200 corresponding to variable n in state memory 102 (step S1012). Control unit 110 substitutes 1 into variable F of the recording medium (step S1014). Control unit 110 reads out a command corresponding to variable F from restoring procedure memory 101 (step S1016). Control unit 110 transmits the prepared command to display 200 corresponding to variable n through communication interface 107 (step S1018). However, when variable n corresponds to management display 200A, the command prepared by control unit 110 is executed.

Control unit 110 determines whether the lamp state in the operation state of display 200 corresponding to variable n matches the lamp state in the standard operation state of network system 1B or not (step S1020). When the lamp state in the operation state of display 200 corresponding to variable n matches the lamp state in the standard operation state of network system 1B (YES in step S1020), control unit 110 executes the processing starting from step S1028.

When the lamp state in the operation state of display 200 corresponding to variable n does not match the lamp state in the standard operation state of network system 1B (NO in step S1020), control unit 110 determines whether F is equal to 2 or not (step S1022). When F is not equal to 2 (NO in step S1022), control unit 110 increments variable F (step S1024), and repeats the processing starting from step S1016.

When F is equal to 2 (YES in step S1022), control unit 110 transmits the identification information of display 200 corresponding to variable n and a message indicating that the restoration is difficult to management PC 500 through communication interface 107 (step S1026). Control unit 110 determines whether variable m is equal to n or not (step S1028). When m is not equal to n (NO in step S1028), control unit 110 increments variable n (step S1030), and repeats the processing starting from step S1010.

When variable m is equal to n (YES in step S1028), control unit 110 ends the lamp state restoring processing.

### Third Embodiment

A third embodiment of the invention will be described below. In network system 1B according to the second embodiment described above, one display 200A for management included in network system 1B performs the determination whether all displays 200 require the restoring processing or not. In a network system 1C according to the third embodiment, however, a management server performs the determination whether all displays require the restoring processing or not. In other words, network system 1B according to the second embodiment can be deemed as the system in which the management server and one of the displays in the third embodiment are implemented by a common device.

Description of substantially the same structures as those in network system 1A according to the first embodiment is not repeated.

<Structure of Network System 1C>

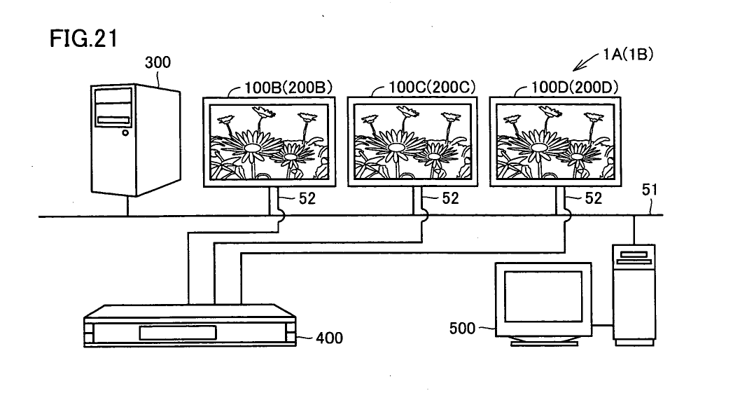

First, a whole structure of network system 1C according to this embodiment will be described below. FIG. 21 is an image diagram showing the whole structure of network system 1C according to the embodiment.

Referring to FIG. 21, network system 1C includes a management server 300, the plurality of displays 200B, 200C and 200D, contents output device 400 and management PC 500. Each of management server 300 and the plurality of displays 200B, 200C and 200D performs mutual communication with management PC 500 over first network 51. Each of management server 300 and the plurality of displays 200B, 200C and 200D performs mutual communications with contents output device 400 over second network 52.

LCD or plasma televisions or the like implement displays 200A, 200B, 200C and 200D, respectively. For example, a wired or wireless LAN, RS-232C, HDMI-CEC (High Definition Multimedia Interface-Consumer Electrons Control) or the like implements each of first and second networks 51 and 52.

However, management server 300 and contents output device 400 may be the same device. Also, management PC 500 and contents output device 400 may be the same device. First and second networks 51 and 52 may be the same network.

Network system 1C may include a plurality of contents output devices 400. In this case, the plurality of displays 200B, 200C and 200D receive different contents through a plurality of input terminals from the plurality of contents output devices 400, respectively.

Alternatively, contents output device 400 may output a plurality of contents through different output terminals, respectively. In this case, the plurality of displays 200B, 200C and 200D receive the different contents from the different output terminals of contents output device 400 through the plurality of input terminals, respectively.

The plurality of displays 200B, 200C and 200D display the contents received from contents output device 400 through network 52. In this embodiment, the plurality of displays 200B, 200C and 200D receive the same contents from contents output device 400, and display the same contents.

Network system 1C according to the third embodiment corresponds to a structure in which management display 200A in network system 1C according to the second embodiment is replaced with management server 300. Therefore, description of the operation summary of network system 1C according to the third embodiment is not repeated.

A form of a specific structure of management server 300 according to this embodiment will be described below. In the following description, displays 200B, 200C and 200D may be generally referred to as displays 200.

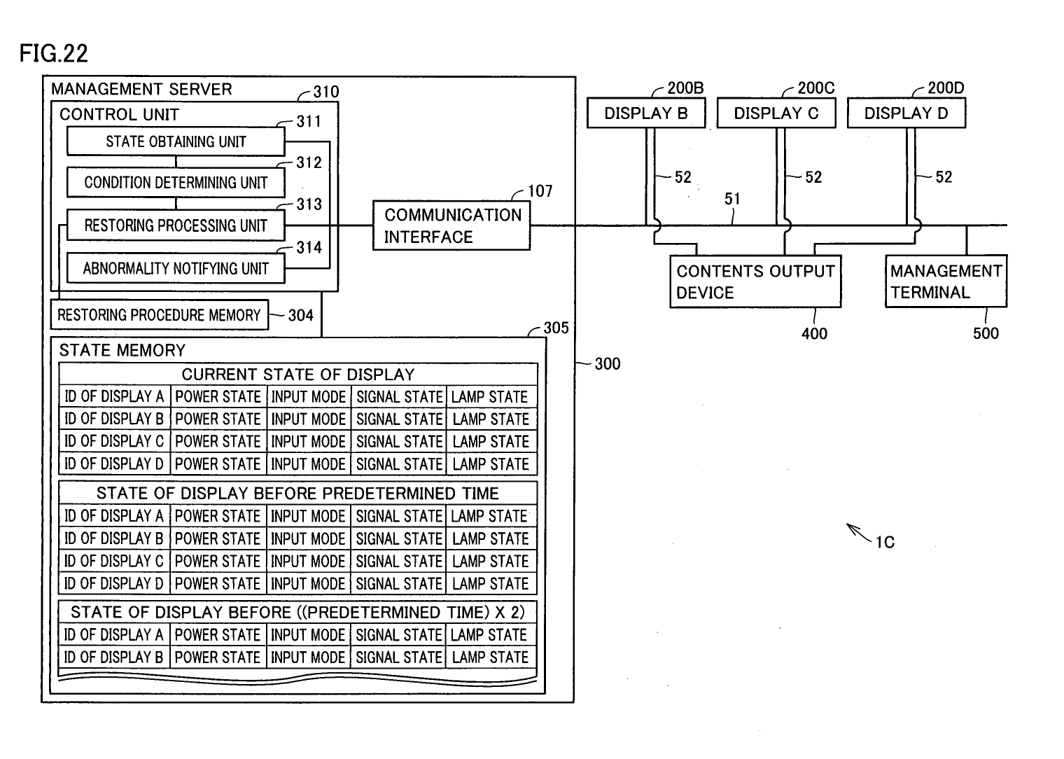

FIG. 22 is a block diagram showing a structure of management server 300 according to this embodiment. Referring to FIG. 22, management server 300 includes, as major components, control unit 110, restoring procedure memory 101, state memory 102 and communication interface 107. Control unit 110 according to this embodiment differs from control unit 110 of the second embodiment in that the restoring processing in management server 300 is not executed, and that consideration is not given to the operation state of management server 300. Other structure of management server 300 according to this embodiment are substantially the same as the corresponding structures in management display 200A according to the second embodiment, and therefore description thereof is not repeated.

The structures of displays 200B, 200C and 200D are substantially the same as those of displays 200B, 200C and 200D according to the second embodiment, and therefore description thereof is not repeated.

Various processing procedures in management server 300 according to this embodiment will be described below. Various kinds of processing (steps) may be implemented by control unit 110 executing the programs, or various function blocks (state obtaining unit 111, condition determining unit 112, restoring processing unit 113 and abnormality notifying unit 114) may implement them by hardware circuits.

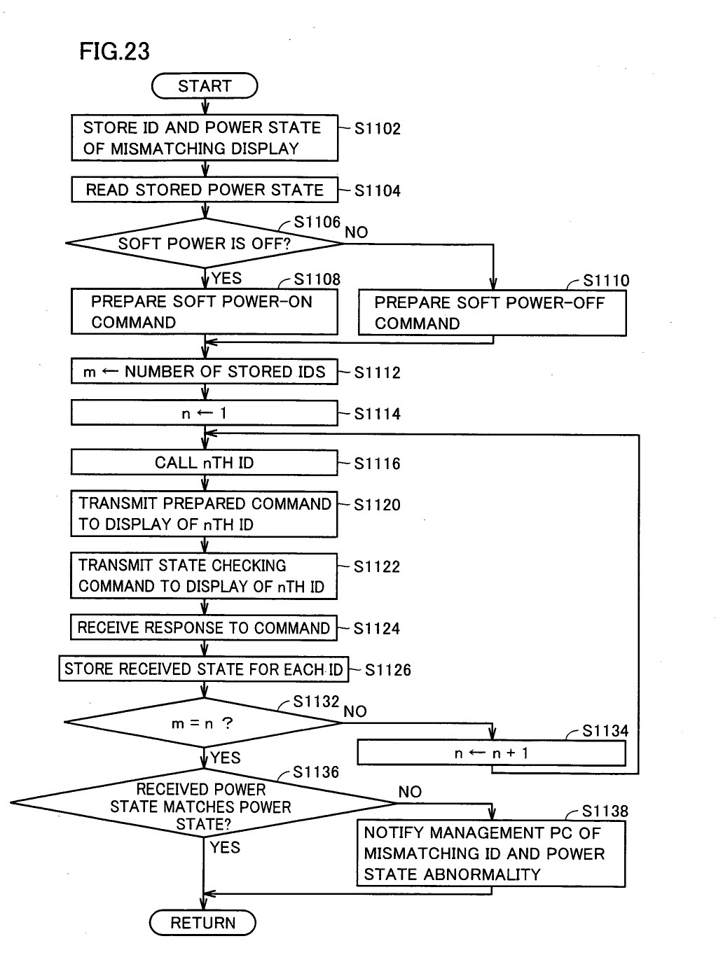

FIG. 23 is a flowchart showing the processing procedure of the power restoring processing in management server 300 according to this embodiment. As shown in FIG. 23, various kinds of processing in management server 300 according to this embodiment differ from the various kinds of processing in management display 200A according to the second embodiment in that the restoring processing in management server 300 is not executed, and that consideration is not given to the operation state of management server 300.

For example, management server 300 according to this embodiment differs from management display 200A in that the processing corresponding to steps S718, 728 and 730 according to the second embodiment is not executed. Also, management server 300 according to this embodiment differs from management display 200A in that management server 300 does not execute commands by itself in steps S812, S916, S930, S946 and S1018 according to the second embodiment.

Other steps according to this embodiment are substantially the same as those according to the second embodiment, and therefore description thereof is not repeated.

### Other Embodiments

Naturally, the invention can be applied to the case where it is implemented by supplying programs to the system (network system 1A, 1B or 1C) or the devices (displays 100A-100D, 200A-200B or management server 300). A recording medium storing the programs that are represented by software for implementing the invention may be supplied to the systems or the devices, and computers (or CPUs or MPUs) in such systems or devices may read and execute program codes stored in the recording medium to offer the effect of the invention.

In this case, the program codes themselves read from the recording medium implement the function of the foregoing embodiments, and the recording medium storing such program codes constitutes the invention.

The recording medium for supplying the program codes may be a hard disk, optical disk, magneto-optical disk, CD-ROM, CD-R, magnetic tape, nonvolatile memory card (IC memory card), ROM (e.g., mask ROM or flash EEPROM) or the like.

Naturally, in addition to the case where the functions of the foregoing embodiments are implemented by executing the program code read by the computer, the invention includes the case where the practical processing is partially or entirely executed by an OS (Operating System) operating on the computer and such processing implements the functions of the foregoing embodiments.

Naturally, the invention includes the case where the program codes read from the recording medium are written into the memory arranged on a feature-expansion board fitted into the computer or a feature-expansion unit connected to the computer, and then a CPU or the like arranged on the function-expansion board or function-expansion unit performs a part or whole of the actual processing based on instructions of such program code so that the functions of the foregoing embodiment are achieved.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A network system comprising a plurality of displays, and a managing device, wherein
each of said plurality of displays includes:
a screen,
a first interface for communicating with said managing device, and
a first processor for transmitting an operation state of said display through said first interface to said managing device and controlling said display based on a command provided from said managing device; and
said managing device including:
a second interface for communicating with said plurality of displays,
a memory for storing said operation states corresponding to said plurality of displays, respectively, and
a second processor for transmitting, through said second interface, to one of said displays said command for causing said one of the displays to perform the same operation as the other displays, based on said operation states, stored in said memory, corresponding to said plurality of displays.

2. The network system according to claim 1, wherein
said managing device is a display including a screen; and
said second processor operates to store the operation state of the managing device in said memory, and
to cause said managing device to perform the same operation as the other displays based on the operation states corresponding to said managing device and said plurality of displays.

3. The network system according to claim 1, wherein
said second processor determines whether the operation states corresponding to said plurality of displays are the same operation state or not, with reference to said memory, and
when a difference is present between said operation states, said second processor transmits said command to said display other than the displays corresponding to the largest value in number by making a comparison in number between said displays corresponding to said respective different operation states.

4. The network system according to claim 1, wherein
said network system further comprises a contents output device for providing contents,
each of said displays further includes a third interface for communicating with said contents output device, and
said first processor displays on said screen the contents received from said contents output device through said third interface.

5. The network system according to claim 4, wherein
said third interface includes a plurality of input terminals, and
said operation state includes a state of selection of the input terminal receiving said contents being displayed on said screen.

6. The network system according to claim 4, wherein
said operation state includes an attribute of an input signal of said contents being displayed on said screen.

7. The network system according to claim 6, wherein
when the attribute of the input signal of said one of the displays is different from the attributes of the input signals of the other displays, said first processor changes the input destination of said contents to another input destination and then restores the input destination based on said command.

8. The network system according to claim 1, wherein
said operation state includes an on/off state of a power.

9. The network system according to claim 1, wherein
when said managing device is powered on, said second processor transmits said command to said display through said second interface based on the operation state corresponding to said plurality of displays.

10. The network system according to claim 1, wherein
said network system further comprises a management terminal for communicating with said managing device, wherein
said second processor receives said operation state from said plurality of displays after transmitting said command,
determines whether said plurality of displays are in said same operation state or not, and
when said plurality of display devices are not in said same operation state, transmits an alarm to said management terminal through said first communication interface.

11. A network system comprising a plurality of displays, wherein
each of said plurality of displays includes:
a screen,
a first interface for communicating with the other displays,
a first processor for transmitting an operation state of one of said displays to the other displays and receiving the operation states from the other displays through said first interface, and
a memory for storing said operation states corresponding to said plurality of displays; and
said first processor causes said display to perform the same operation as the other displays based on said operation state corresponding to said plurality of displays.

12. A managing method in a network system including a plurality of displays and a managing device, comprising the steps of:
transmitting, by each of said plurality of displays, an operation state of said display to said managing device;
storing, by said managing device, said operation states corresponding to said plurality of displays in a memory;
transmitting, by said managing device, said command for causing said display to perform the same operation as the other displays based on said operation states corresponding to said plurality of displays; and
changing, by each of said plurality of displays, the operation state of said display based on a command provided from said managing device.

13. A managing method in a network system including a plurality of displays, comprising the steps of:
transmitting, by each of said plurality of displays, an operation state of said display to the different display;
storing, by each of said plurality of displays, said operation states corresponding said plurality of displays in the memory; and
changing, by each of said plurality of displays, the operation state of said display to the same operation state as the other displays, based on said operation states that corresponding to said plurality of displays.
